(19) United States
(12) Patent Application Publication
(10) Pub. No.: US 2005/0228736 A1
(43) Pub. Date: Oct. 13, 2005

(54) Method and system for an auction

(76) Inventors: Jeff Norman, Toronto (CA); Chris Twist, Toronto (CA); Doug Campbell, Toronto (CA)

Correspondence Address: John R.S. Orange;McCarthy Tetrault LLP, 66 Wellington Street West, Suite 4700, P.O. Box 48, Toronto, ON, M5K 1E6, CA

(21) Appl. No.: 10/798,420

(22) Filed: Mar. 12, 2004

Related U.S. Application Data
(60) Provisional application No. 60/453,773, filed on Mar. 12, 2003.

(51) Int. Cl. G06F 17/60

(52) U.S. Cl. 705/37; 705/1

(57) ABSTRACT

An auction system for conducting an online auction of merchandise in a plurality of lots presented on a webpage between a bidder and a seller in a communication network. The system having a host computer associated with an auction host, a bidder computer and a seller computer coupled to the host computer. The computers include a computer usable medium having a plurality of program code to execute instructions associated the auction, including program codes for administering and managing the auction, defining the webpage interface, updating of dynamic elements within the webpage in real-time, enabling negotiation of a sale of the merchandise.

### BACKGROUND OF THE INVENTION

1. Field of the Invention

The present invention relates to method and system for an auction, more particularly it relates to an online auction.

2. Description of the Prior Art

An auction is a well known technique for selling merchandise organised as lots. Typically, successive bids are accepted until the highest bid is obtained. Other forms of auctions, such as “Dutch” auctions may be held in which the price of a lot is reduced until someone makes a bid for it. Auctions are sued to sell many different types of merchandise, including fine art, houses and personal effects widespread use is made of auctions in the automobile industry to distribute used automobiles between dealers.

In the world of automobiles, almost 10 million automobiles were sold at dealer auctions in North America during 1999. Although, the sales of used cars between dealers is a growing financial marketplace, there exists tremendous inherent costs and loss of revenue for sellers. Firstly, the cost to transport a car from the seller's location to the auction is quite considerable. Furthermore, unsold automobiles are generally held over until the next auction which may not occur for a number of days. Also, fees are generally paid to the auction holders, according to selling price. Overall, an extra cost of approximately $1000 to the seller is incurred in most cases. This amount may represent more than 10% of the seller's profit.

With the advent of the Internet, some automobile auctions are being practised online via a web browser on a computer. This helps to reduce the extra costs which the seller may incur if they were selling the car at an automobile auction. However, for such auctions the trading lasts for a prolonged period of time, and the buyer must constantly refresh the web browser screen to view the latest updated bid from the online auction system. Generally, the users view hypertext mark-up language (HTML) documents and enter data into a form but any further processing requires the HTML form to be submitted back to the server where a new page is rendered and returned to the client, sometimes called a “hard refresh”. Performing a hard refresh every time the client requests information causes unnecessary strain on the network since the same, unchanged data sent back to the client. This may be quite problematic for buyers who have low speed Internet connections. Also, buyers who have comparatively faster connection speeds, such as an ISDN line or DSL have a better opportunity to make last minute offers for cars available in the automobile auction.

In physical auctions for the wholesale segment, the buyers of used vehicles generally rely on the auctioneer to provide accurate information about the vehicles and to coordinate payment. For example, the auctioneer can physically inspect the car to verify data about a vehicle before listing the vehicle in the auction program, and the buyers can physically inspect the vehicles before or during the auction. In a business-to-business electronic auction for used vehicles, a buyer in the wholesale segment cannot physically inspect the vehicles itself because the vehicles are not located at a single site. The buyers are thus expected to rely on the electronic auction site to provide accurate, verified information. The electronic auctioneer, however, cannot physically inspect the vehicles itself to verify the information provided by the sellers because the vehicles are located all across the country.

It is therefore an object of this invention to mitigate at least one of the above-mentioned disadvantages.

### SUMMARY OF THE INVENTION

In one of its aspects there is provided an auction system for conducting an online auction of merchandise in a plurality of lots presented on a webpage between a bidder and a seller in a communication network, the system having a host computer associated with an auction host, a bidder computer and a seller computer coupled to the host computer; the computers having a computer usable medium having a plurality of program codes for executing instructions pertaining to the auction; the plurality of program code including a first computer readable program code for administering and managing the auction by defining characteristics and parameters of the auction as dictated by the auction host; a second computer readable program code for defining the webpage interface presented on the bidder computer and the seller computer; a third computer readable program code for defining real-time updating of dynamic elements within the webpage associated with a status of sale of the merchandise; a fourth computer readable program code for defining a method for recording actions of the bidder and the seller to the host computer in real-time and presenting the actions on the webpage in real-time; a fifth computer readable program code for enabling negotiation of a sale of the merchandise between the bidder and the seller after a predetermined time as specified is the parameters; wherein the auction is conducted in real-time between the bidder and the seller within the network.

In another of its aspects there is provided a method a method of dynamically updating elements included in a document at a client computer in real time from a host computer, the elements having class components and data components, the method having the steps of loading the document in the client computer; scanning the document to recognize the class components and the data components; collecting and storing the class components at the client computer; the client computer requesting an update of the class components from the host computer; determining whether the class components already exist at the client computer and determining whether the class components at the client computer are out of date; requesting the class components from the host computer if the class components do not exist at the client computer or are out of date, otherwise instantiating the class components to yield class instances; executing the class instances; the client broker requesting an update of the data components from the host computer via the server broker; the server broker determining whether the data components exist at the client computer, or are out of date; the server broker initiating a data request from the host computer if the data components do not exist or are out of date; and updating the data components and class components on the webpage.

Advantageously, the webpage is updated in a selective manner by updating only those components that require updating, thus permitting updating of the webpage in real-time without a hard refresh, and minimizing strain the network resources.

### BRIEF DESCRIPTION OF THE DRAWINGS

These and other features of the preferred embodiments of the invention will become more apparent in the following detailed description in which reference is made to the appended drawings, by example only, wherein:

FIG. 1 is an overview of an auction system for facilitating a method for buying and selling merchandise;

FIG. 2a is an auction page;

FIG. 2b is an overview of a update sub-system for enabling live webpage updates;

FIG. 3a is a flowchart outlining the steps for performing a live update of a webpage;

FIG. 3b is a flowchart outlining the steps for performing a live update of a webpage;

FIG. 4 is a log in screenshot;

FIG. 5 is a dealer registration page;

FIG. 6 is a user interface for uploading a dealer license;

FIG. 7 is a subscriber administration page including a dealership administration menu;

FIG. 8 is subscriber administration page including an input page for dealership details;

FIG. 9 is a subscriber administration page including a user interface for uploading a dealership license;

FIG. 10 is a subscriber administration page including an input page for dealership location details;

FIG. 11 is a subscriber administration page including an input page for employee details;

FIG. 12 is an auction administration menu;

FIG. 13a is an auction class administration page showing parameters of an exemplary auction;

FIG. 13b is an auction class administration page showing parameters of an exemplary auction;

FIG. 14 is an interface for submitting a vehicle;

FIG. 15 is menu for submitting vehicles;

FIG. 16a is an input page for submitting vehicle details;

FIG. 16b is an input page for submitting vehicle details;

FIG. 16c is an input page for submitting vehicle details;

FIG. 17a is an input page for submitting a vehicle appraisal;

FIG. 17b is an input page for submitting a vehicle appraisal photographs;

FIG. 18 is an input page for requesting a vehicle appraisal;

FIG. 19 is a page displaying status of scheduled auctions;

FIG. 20 is an auction page;

FIG. 21 is a vehicle search page;

FIG. 22 is a vehicle search page including search criteria;

FIG. 23 is an auction sales page including results meeting the search criteria of FIG. 23; and

FIG. 24 is an auction purchases page showing at the end of a negotiation;

FIG. 25 is an interface for negotiating;

FIG. 26 is an interface for placing and accepting offers during negotiation; and

FIG. 27 shows a history of bid information of an auction.

### DESCRIPTION OF THE PREFERRED EMBODIMENTS

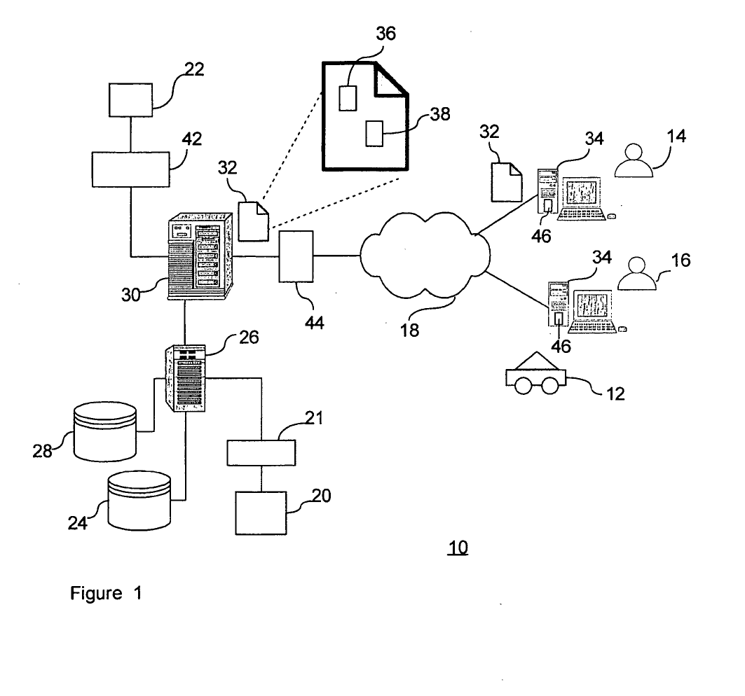

Reference is first made to FIG. 1, which is an overview of an auction system 10 for facilitating a method for buying and selling merchandise, which will be considered to be automobiles 12, in a preferred embodiment. The system 10 enables buying and selling of vehicles 12 between a buyer 14 and a seller 16, via a communications network 18. The buyer 14 and seller 16 are typically car dealers belonging to an auto dealership. The auction system 10 is operated and administered by an auction provider or an auctioneer 20 via an auction administration module 21. Thus, the auctioneer 20 allows a plurality of auction holders 22 to use the system 10 by setting up an auction and conducting an auction between a plurality of dealers 14, 16 in a network environment. Although the auction holder 22 may be a separate entity from the buyer 14 or the seller 16, the auction holder 22 may also be a buyer 14 or a seller 16. Thus, the buyer 14 and seller 16 may be human agents or software agents configured to participate in an auction.

The communication network 18 may be any network such as a local area network (LAN), a wide area network (WAN) or the Internet. The system 10 includes a vehicle database 24, an auction server 26, an auction database 28 and a web server 30, communicatively coupled to each other. The web server 28, which may be a hypertext transfer protocol (HTTP) server, is a process running at a web site which serves an object, such as a web page 32, in response to HTTP requests from a web browser on dealer computers 34. Each web page 32 is associated with a uniform resource locator (URL) pointing to its location on the web server 30. Thus, any web page 32 may be accessed by entering an appropriate URL in a web browser, such as Microsoft Internet Explorer.

The dealer computers 34 are typically computing devices that are, but not limited to, personal computers, handheld devices, cell phones, pagers and microprocessor-based wireless information devices. The dealer computers 34 include a processing unit, a computer readable medium including ROM, flash memory, non-volatile RAM, a magnetic disk, an optical disk, an IC memory card or a magnetic tape. Also, the dealer computers 34 execute an operating system such as Microsoft® Windows 9x, Me, XP, Windows CE, UNIX, Pocket® PC OS or Palm OS®. The dealer computers 34 are communicatively coupled to the Internet 14 via a dial-up modem, a broadband connection (Cable/xDSL, wireless), or via a direct connection. Also included in the computer readable medium of the dealer computers 34, is a suitable web browser application, such as Microsoft Internet Explorer.

In a preferred embodiment, the vehicle database 24 and auction database 28 support an object-relational database or structured query language (SQL) database, such as Oracle9i® Database, from Oracle Corporation, Redwood, Calif., USA. Therefore, the vehicle database 24 responds to queries from dealer computers 34 formatted in the PL/SQL language. The web server 30 runs web server software such as Microsoft IIS 4.0. Generally, the auction server 26 and the web server 30 are chosen such that they are upwardly scalable, and easily integrated with each other and with the desired operating system, such as Microsoft Windows 9x. The web server 30 is coupled to the network 18 via a firewall 23. Typically, the firewall 40 may be a sub-system of computer software and hardware that intercepts data packets before allowing them into or out of the communication network 18, such as the Internet. The firewall 40 determines whether or not to allow data packets to pass based upon a security policy.

The dealer 14, 16 specify a bid for a vehicle through a sequence of webpage forms 32 to hand off bid information to the auction server 26 for storage in the auction database 28. The auction database 28 includes a daemon process for monitoring the auction database 26 for events to process or bids to verify. Thus, the auction database 26 stores the details of each auction bid and each transaction. The auction server 26 runs auction programs to implement the auction rules and policies. Each auction program can be implemented in multiple concurrent processes, each one managing a different auction. The auction holder 22 sets up an auction and manages same via an auction management module 42. Thus, the auction holder 22 can adjust the parameters that affect the behaviour of the auction, these parameters can vary by auction and are set according to the policies of the auction holder 22. The auction parameters can be changed at any time, however, parameters will not usually be changed for an auction that is in progress, but may be necessary to correct problems.

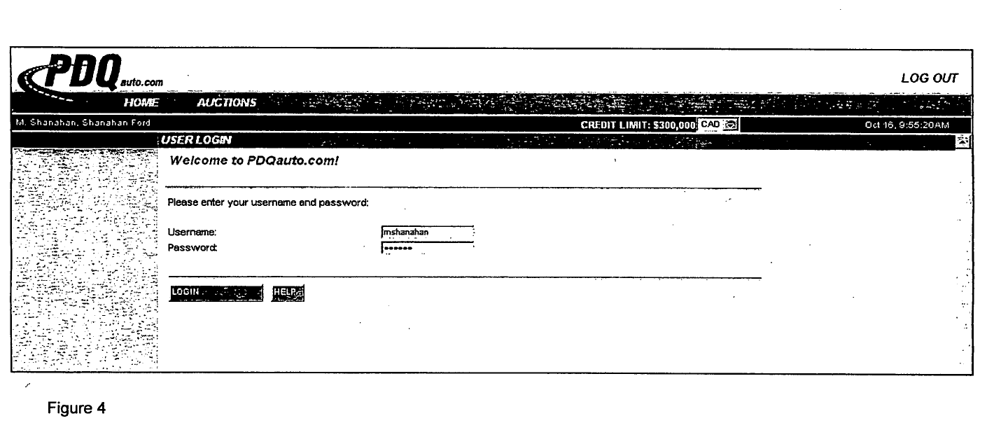

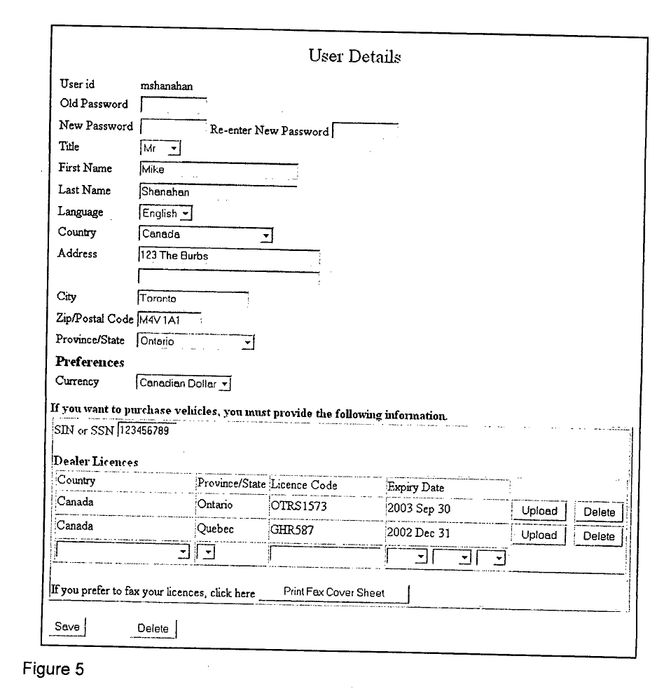

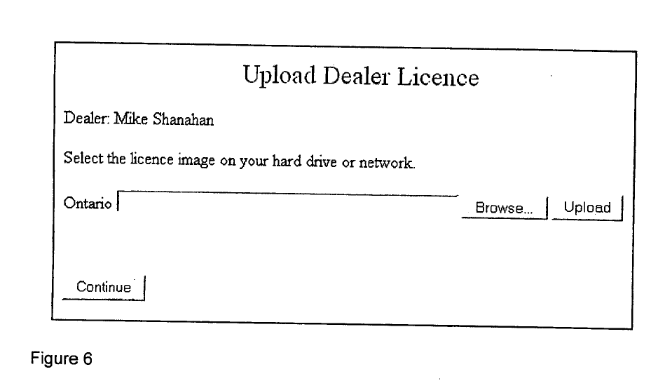

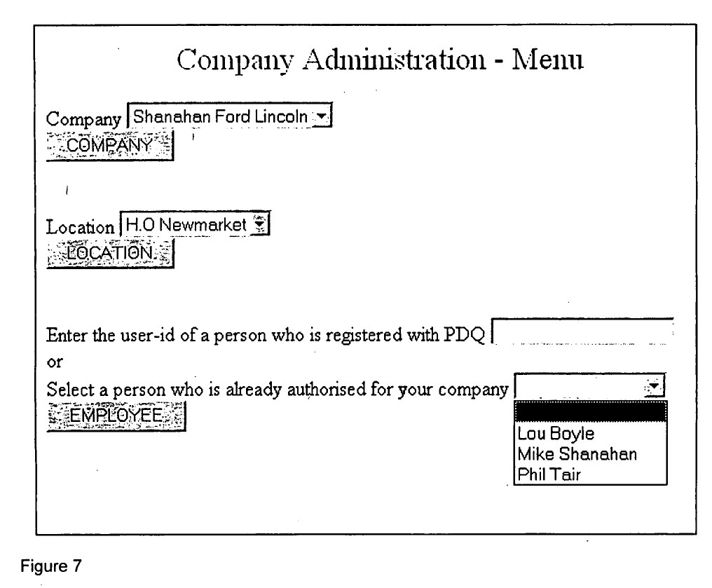

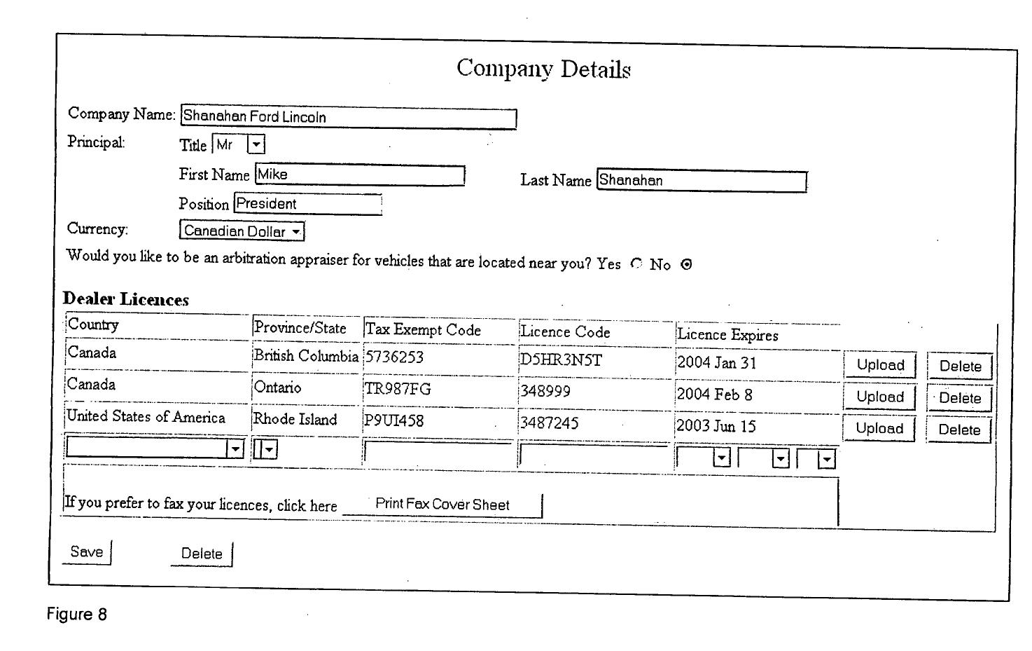

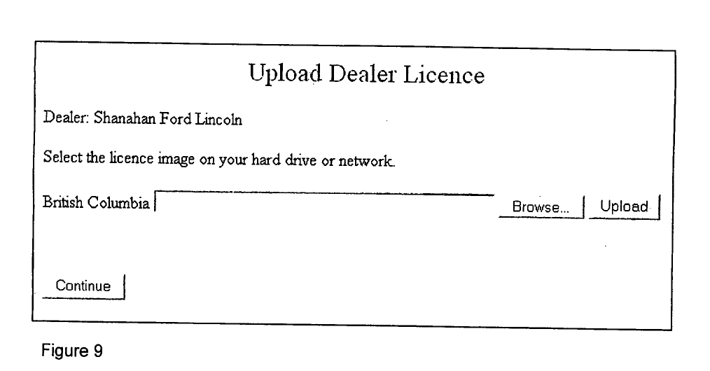

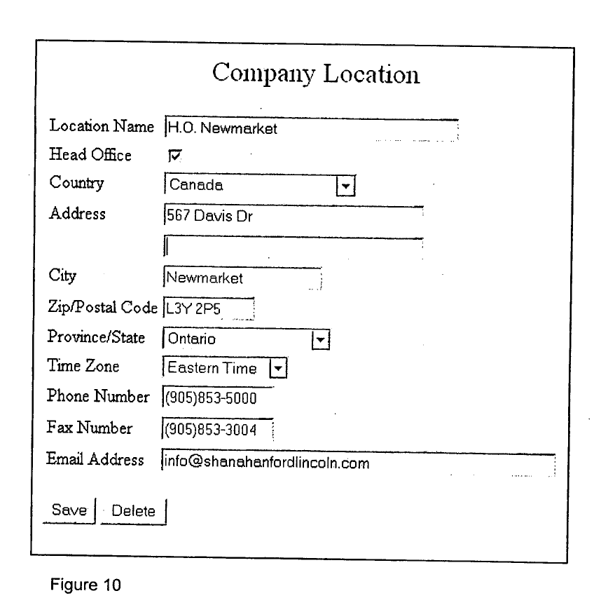

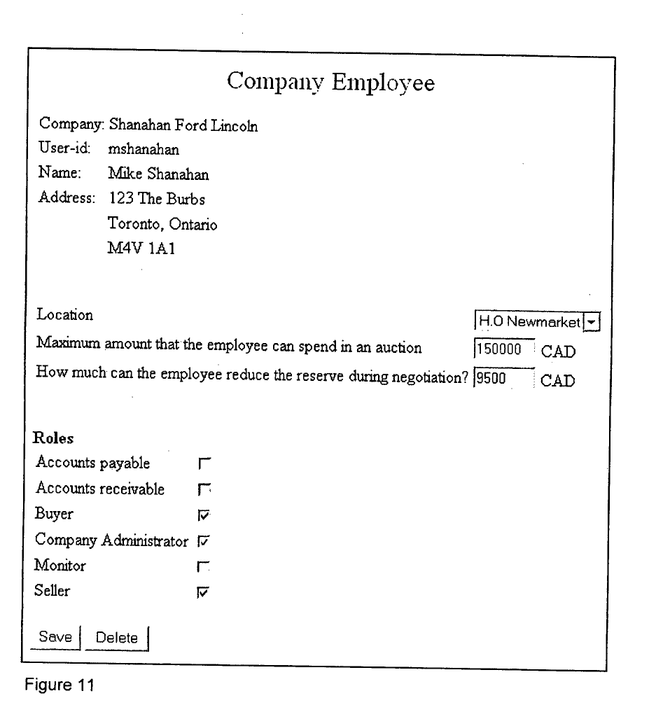

The initialisation of an actuator will first be described followed by the subsequent conduct of the auction. The initialised ad conduct will be described in terms of the functionality achieved through the interaction of the client server relationships established by the system 10. The system 10 is accessible only to registered users or dealers 14, 16. Thus, an auction holder 22 initially gains access to the system 10 by logging on via a secure webpage 32 by providing a username recognized by the system 10 and a challenge response, in the form of a password, as shown in FIG. 4. The auction holder 22 provides details pertaining to the dealership, such as ownership and administrative information, dealer licenses in authorised jurisdictions, employees authorised to use the system 10 and their positions within the company, geographical location and contact information. Typically, the dealers 14, 16 are employees of a car dealership, a car company or institutions for selling vehicles 12 from bank foreclosures, estates, and so forth. Within such a dealership, at least one of the dealers is selected to conduct the act of selling and/or purchasing cars via the system 10. The registration information includes the dealers' 14, 16 SSN/SIN, contact information, dealership licences, geographical location of the dealership, authorized employees 14, 16 for using the auction system 10, as shown in FIGS. 5 and 6.

Each dealership is then assigned a credit limit, displayed at FIG. 4, by the auctioneer 20, which is separate from any other credit limit that may be assigned by a third party, such as a finance company. The credit balance for these sources is tracked separately. The credit limit may be assigned to a dealership represented by a number of individual dealers, or on an individual basis. Thus, the dealer's 14, 16 spending can be curbed once the credit limit has been reached.

Alternatively, every buyer 14 or seller 16 may have a credit limit by the dealership. The credit limit is displayed as indicated at 200 on FIG. 4 and is incremented or decremented for each transaction.

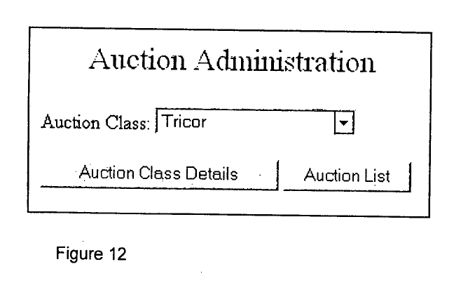

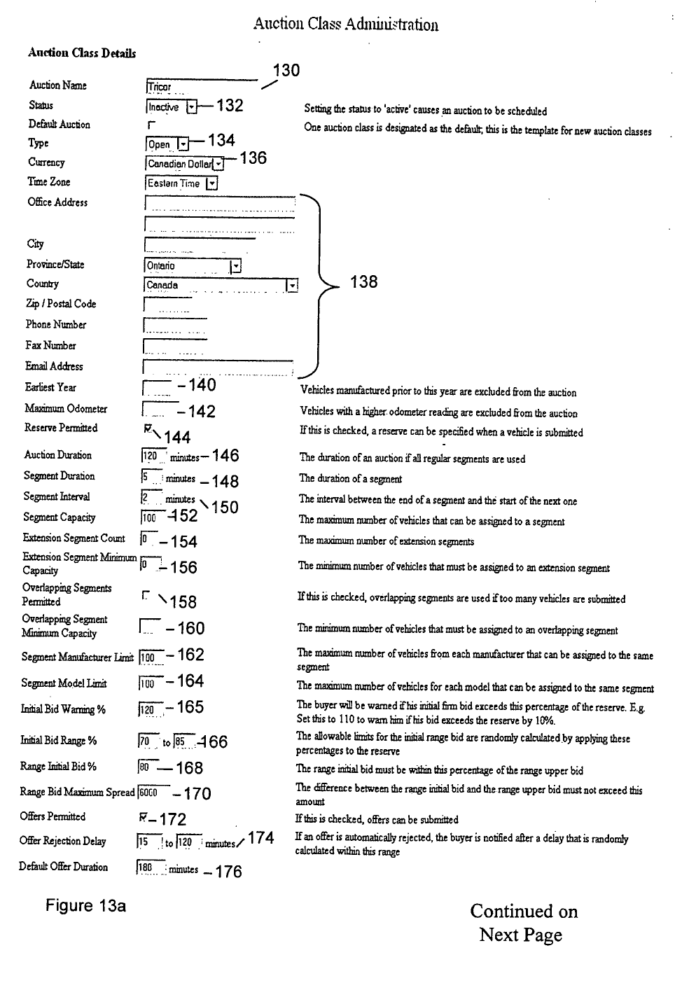

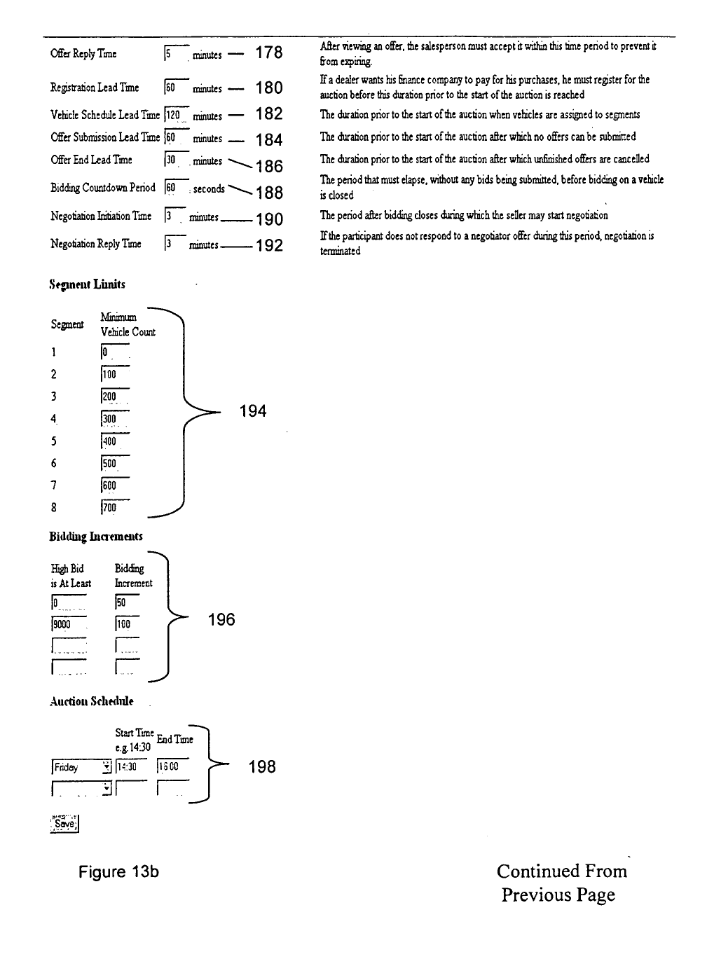

Next, the auction holder 22 chooses a unique identifier for a new auction or selects a predefined auction, such as “Tricor”, in order to edit settings of same, as shown in FIG. 12. Each auction includes the parameters, as will be described below, and details of the vehicles 12 in the different auction segments. These are loaded in the database of the server. Upon actuation of the auction class details button, all the different parameters of the auction named Tricor are presented, as shown in FIGS. 13a and 13b. The auction class details include parameters such as auction name, Tricor, having input field 130, a drop down menu in field 132 to indicate whether the status of the auction, that is whether it is i.e. presently underway active or inactive. Other parameters of the auction include the type input field 134, a choice between an open auction and a closed auction. Generally, in an open auction the vehicles 12 can be purchased by any licensed dealer 14, 16. In a closed auction, the auction is generally held by an organization such as a manufacturer, manufacturer's finance arm, or independent finance arm and restricts sales to the auction holder's 22 own dealer network. A drop down menu for the currency used in the auction is also provided by an input field 136. The default currency of an auction is the currency of the country where the auction is located. However, the dealer may select another currency and the monetary values are then converted to the chosen currency by a utility in the auction holder 22.

The geographical location and the contact details of the auction are provided in input fields 138. The next input field 140 refers to a vehicle manufacture date for which vehicles 12 are eligible for being listed in the auction, and the input field 142 sets the maximum allowable odometer reading for eligibility for auction registration. Generally, the earliest year parameter and the odometer parameter only apply to open auctions and are optional. Another option is the ability to choose displaying the reserve, in step 144.

The next input field 146 sets the duration of the auction, which, in the example, is set to 120 minutes. However, the auction usually finishes before the end of the business day. The auction is subdivided into segments and input fields 148, 150, 152, 154 are used to specify segment duration, segment interval and segment capacity respectively. The length of an auction segment parameter is generally set to 13 minutes. The auction holder 22 determines the appropriate value by analyzing the distribution of bids throughout each auction segment. If bidding slows down significantly during the middle of a segment for more than a couple of minutes, then the segment length may be shortened. Conversely, if there is no significant reduction in bids in the middle of the auction segments, the length of the auction segments should be increased.

The segment interval parameter specifies the number of minutes between consecutive auction segments, this parameter is set to 2 minutes. The auction holder 22 determines the appropriate value by analyzing the proportion of vehicles 12 in the preceding segment for which bidding is still in progress when the new segment starts. Ideally, only a small percentage of the vehicles 12 should still have their bidding in progress when the next segment starts.

Other segment input fields include number of extension segments 154 and capacity of same 156, the number of extension segments parameter specifies the number of segments that can be added on to the end of the auction if all the segments reach capacity. A determination whether overlapping segments are permissible is indicated by the check box 158, and the minimum capacity of the overlapping segments indicated by the check box 160. Generally, overlapping segments are used if the number of vehicles 12 exceeds the auction's capacity. The default setting for this parameter is to allow overlapping segments. Additional segment input fields include the maximum number of vehicles 12 from each manufacturer that can be assigned to each segment 162 and the maximum number of vehicles 12 for each model that can be assigned to each segment, 164. “Overlapping segments allowed” parameter specifies whether or not a segment can start while another one is in progress. Also, an auction segment can be reserved for a specific seller 16, which accommodates high-volume sellers 16. For example GMAC vehicles 12 tend to fetch a higher price, and so by grouping them together, this highlights the vehicles 12′ perceived greater value. A segment reservation only applies to one auction.

The auction class details also include information and parameters regarding bids and offers. Specifically, a buyer 14 is warned if the buyer's 14 initial bid exceeds the reserve. This is accomplished by setting a trigger in input field 165.

The system 10 also permits automated bidding with a range. The allowable limits of a range bid as a percentage of the reserve can be specified in input fields 166. The range initial bid as percentage of the range upper bid is specified in input field 168, while the maximum difference or spread between the range initial bid and the range upper bid is specified in input field 170.

Other parameters regarding offers are described below. To facilitate sale of cars after the segment has finished, the system 10 includes an “after: function that allows a scale to be completed when the reserve has not been met. Thus, the buyer or seller may offer an intermediate price when can be accepted, rejected or countered. A determination whether offers are permissible or not is made in input field 172 and the parameters for the handling of offers are made in input fields 174, 176, 178, 180, 186. The offer rejection period range parameter 174 specifies the minimum and maximum period before the buyer 14 is notified that his offer has been rejected. The offer retention period parameter 176 specifies the default period of time before the seller 16 must reply to an offer. After this period has elapsed from the time the offer was submitted, an offer that has not been accepted by the seller 16 will expire. This parameter is generally set to 60 minutes. If a substantially large volume lot of offers reach their retention limit without being viewed by the seller 16, this parameter may be too low and may need to be adjusted. However, the buyer 14 does not want an offer to remain in effect for too long, as this would prevent the buyer 14 from bidding on an alternative vehicle. Consequently, this parameter is set according to the policies of the auction holder 22, but these policies should be influenced by the expiry statistics. However, the buyer 14 can override the default offer retention period, so when evaluating the expiry of offers, the auction holder 22 takes into account the retention period for each offer.

The bid countdown time parameter 188 specifies the maximum number of seconds that are permitted before bidding on a vehicle is closed. This period is added on to the bid closing time for each vehicle 12, to ensure that bidding is not terminated while bids are still arriving. The value of this bid is determined by analyzing the number of bids that are submitted while bidding is open, but do not arrive in time to be processed. Even if this parameter is set correctly, there may be some bids that fail to arrive on time, due to the unpredictable nature of network 18 traffic, such as traffic bursts or Internet congestion. However, this parameter is set such that under normal circumstances, most bids are accepted. The negotiation parameters are set out in input fields 190 and 192. Other parameters include segment limits input fields 194, bidding increments information 195 and auction schedule input fields 196.

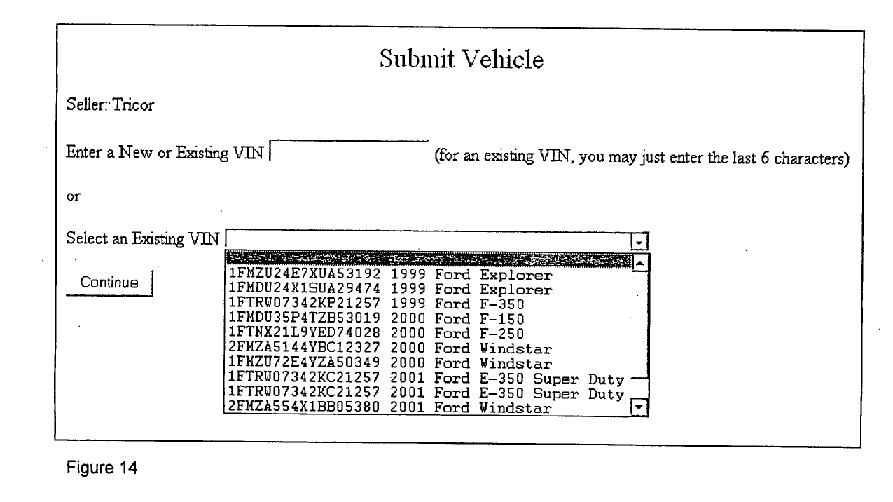

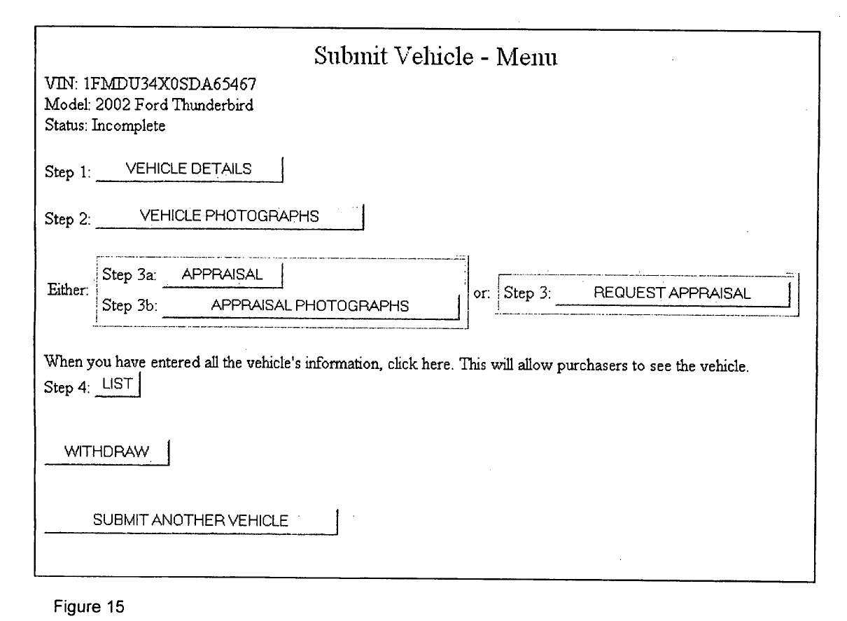

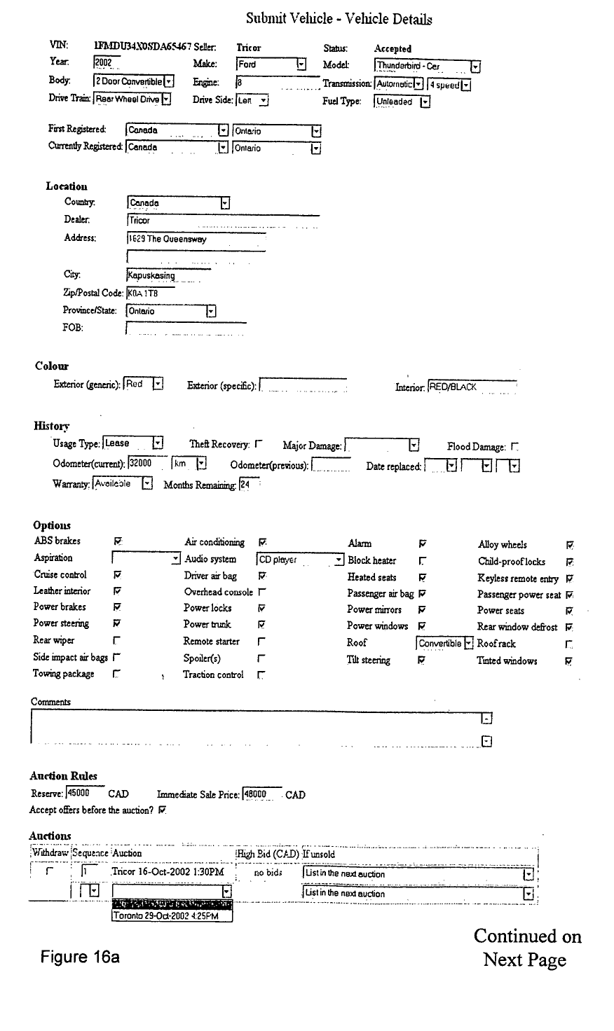

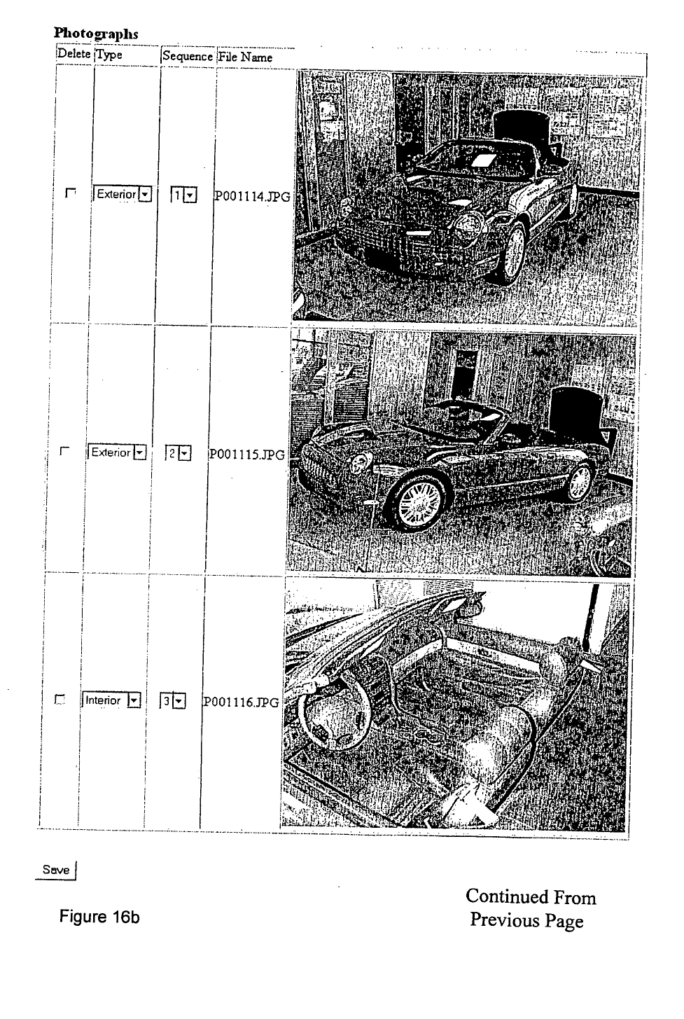

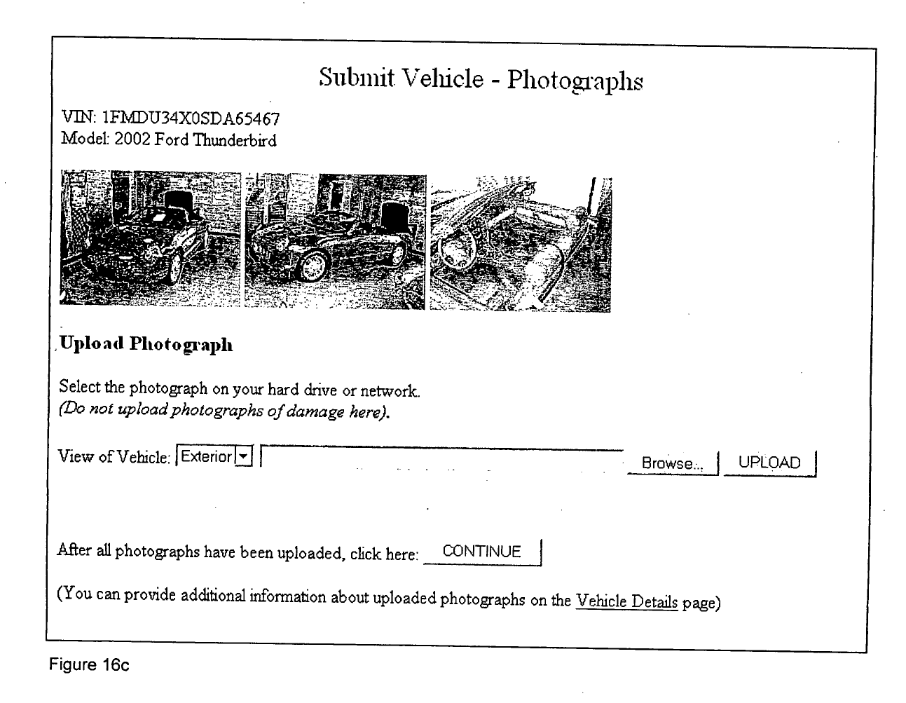

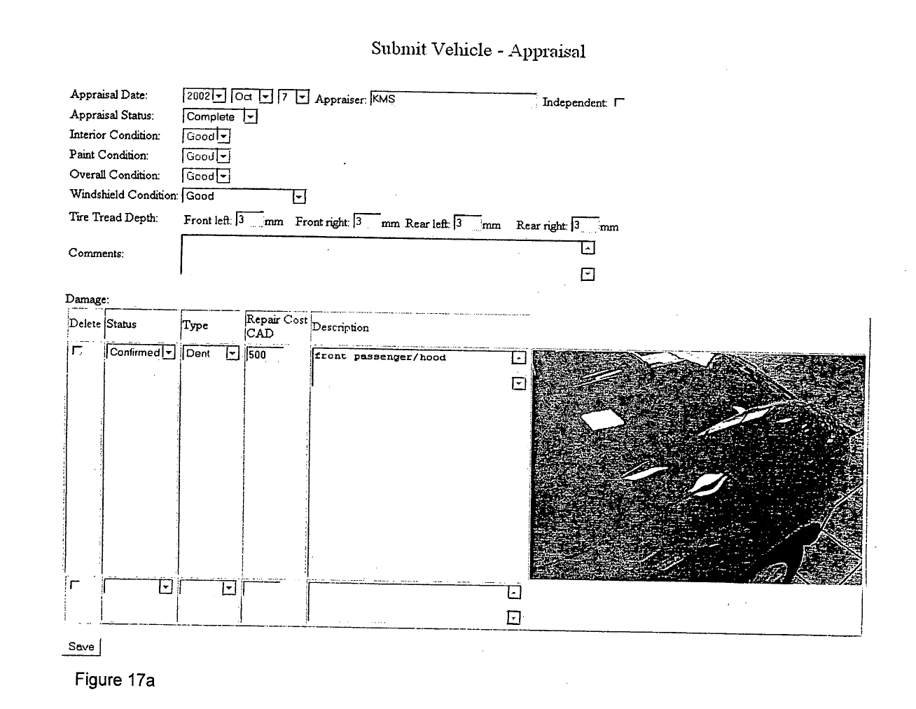

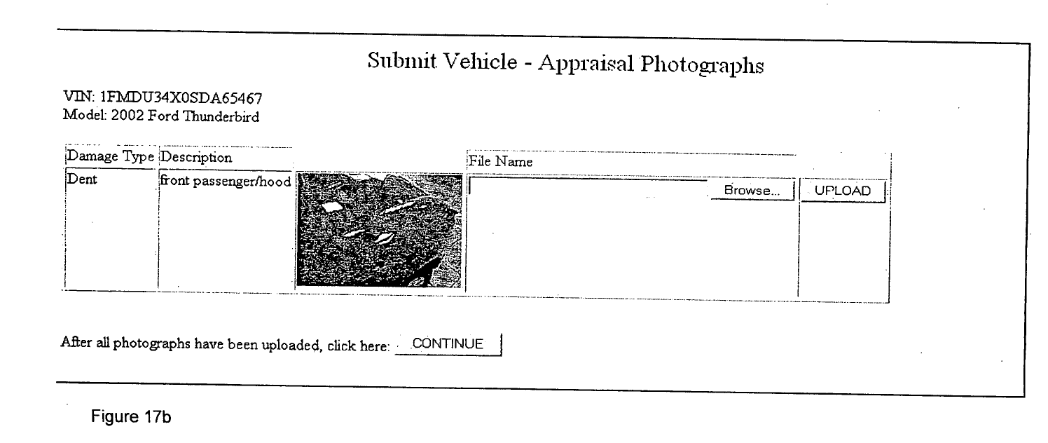

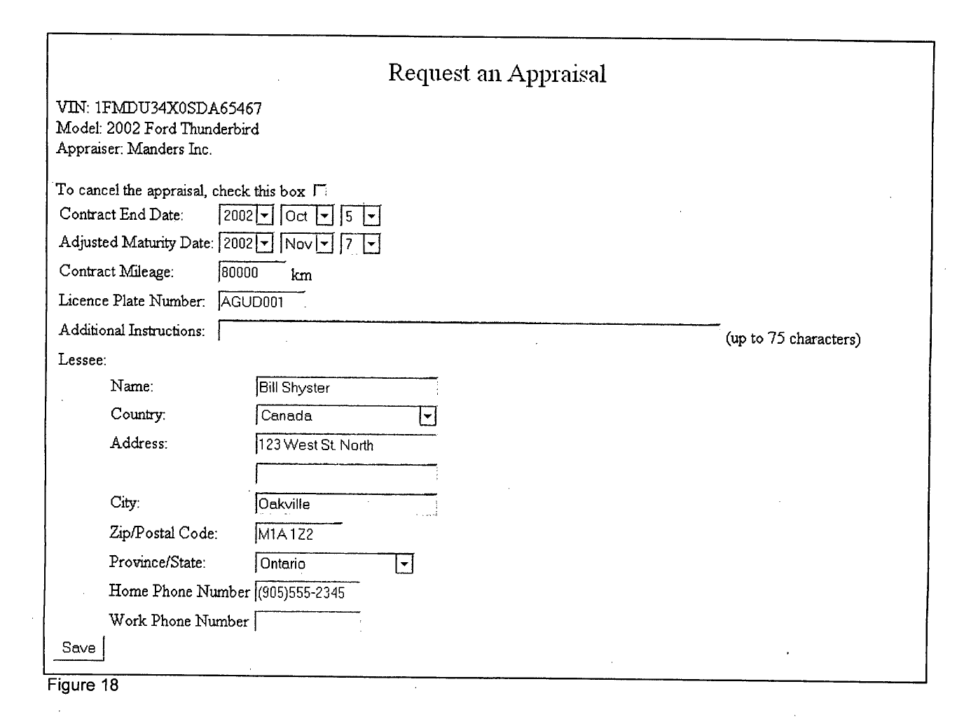

As part of the preparation for the auction, vehicles 12 are submitted for auction by the auction holder 22, as shown in FIG. 14. The vehicles 12 are submitted by the auction holder 22 by entering a vehicle identification number (VIN) and any other a unique identifier dictated by the auction holder 22. The step of submitting vehicles 12 further includes any of the steps of entering vehicle 12 details such as year of assembly, engine size, model type, and submitting photographs. The seller 26 can also request appraisal from a third party, or withdraw a vehicle 12 from the auction. An example of an interface for performing these tasks is shown in FIG. 15. A detailed description of the vehicle is presented in FIGS. 16a, 16b and 16c, where numerous input fields are available for completion in order to give a substantially complete attribute list for the vehicle. Alternatively, having completed an “available vehicle notification” preference query form the purchase can be notified automatically by a number of methods such as by email, facsimile, mail or short message service (SMS), among others. Such notification can occur at a predetermined time by the buyer 14 or it can occur when the vehicle 12 of interest is listed. FIGS. 17a, 17b and 18 show an exemplary page 32 for submitting an appraisal and an exemplary page 32 for requesting an appraisal, respectively.

After the vehicles 12 have been submitted, they are then assigned to segments. This step involves assigning each vehicle to an appropriate auction. Generally, vehicles 12 are assigned before the auction starts, as dictated by the “vehicle schedule lead time” parameter, although this process may be triggered whenever a vehicle is submitted. It also occurs if an auction is created, changed or deleted, so that the assignment of vehicles 12 to auctions needs to be recalculated. If a vehicle has not been withdrawn by the auction holder 22, it is assigned to the next available auction within the auction region that the seller 16 selected. If an auction is in progress, but the final segment has not yet started, it is placed in the current auction. The vehicle is assigned a unique identifier, generally this is a reference number or “entry number” unique to that auction.

Generally, each auction includes at least eight segments and each segment can accommodate at least 100 vehicles 12. In a closed auction, a segment may be reserved for specific makes and/or models. Additionally, overlapping segments may be created if there are too many vehicles 12.

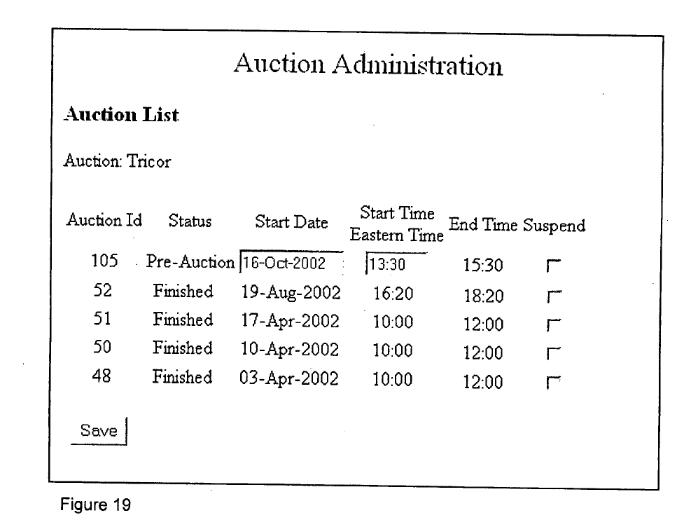

The next step involves scheduling the auction. Generally, the auction holder 22 holds an open auction at predetermined time. The auction is set to run for a predetermined time, typically a maximum of two hours. Thus, the auction holder 22 is responsible for scheduling and managing the auction. An exemplary interface of an auction administration interface is presented in FIG. 19.

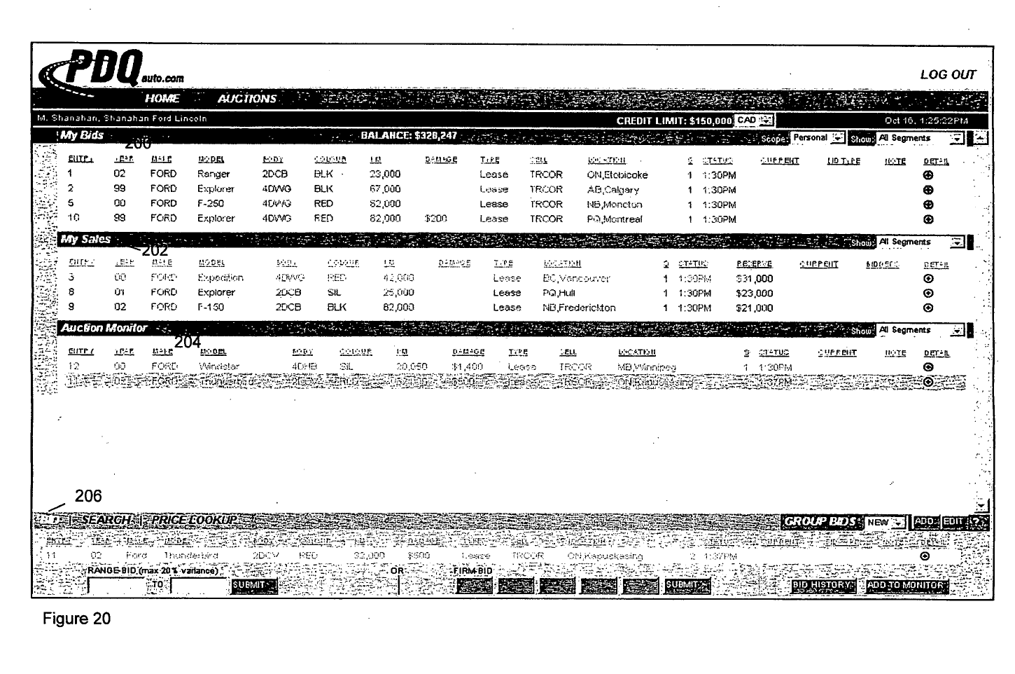

Upon logon and verification the buyer 14 or seller 16 is presented with an auction home page 32 as shown in FIG. 20. The auction home page 32 includes a summary of the auction and a plurality of sections such as “My sales” 200, “My bids” 202, “Auction monitor” 204 and “Bid” 206. The summary fields include User Name, Dealer Name, Auction Name, Credit Limit, Currency and Timestamp. The Auction Name field the name of the currently selected auction, auctions that are in progress or scheduled auctions that are open to the buyer 14. The buyer 14 selects from this list the auction for viewing and the page 32 is refreshed accordingly for each selected auction. The buyer's 14 credit limit is calculated as the lesser of the buyer's 14 credit limit and the buyer's 14 spending limit (if the dealership assigned a spending limit to the buyer 14). Generally, the buyer's 14 credit limit is the sum of the buyer's 14 credit limit and the buyer's 14 credit limit with each of the finance companies that the buyer 14 selected when he registered for the auction. The currency field includes a drop-down list of all the currencies that the auction supports, and when this is changed, all of the monetary amounts on this page 32 are redisplayed in the selected currency. The Timestamp field shows the current date and time, in the user's preferred time zone, as determined from the clock on the auction server.

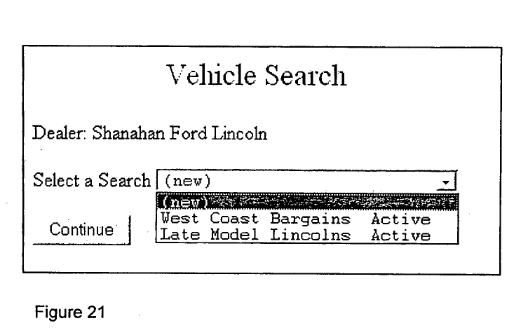

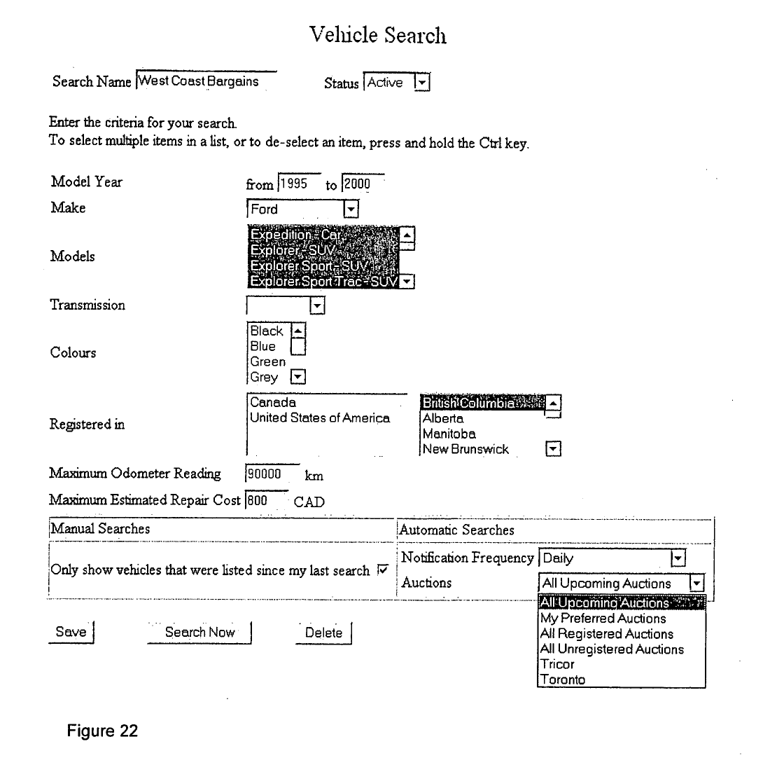

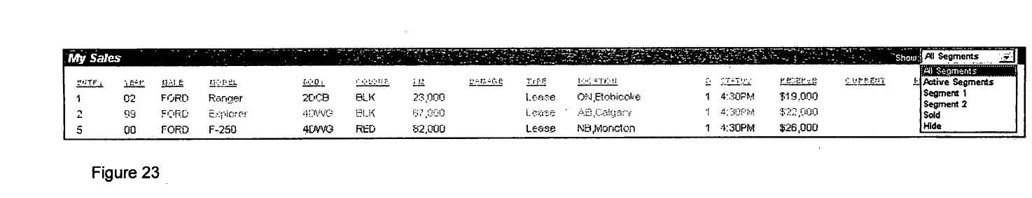

The home page 32 also provides a section, “My Sales”, that allows a seller 16 to monitor his sales within a specific auction, as shown in FIG. 20. The seller 16 chooses the segment for the vehicles he has up for auction by performing a vehicle search as shown in FIG. 21 and FIG. 22. The vehicle query page 32 includes the following input fields, manufacture date, model, transmission type, colour, maximum odometer reading, among others. For example, FIG. 22 shows a search query for all vehicles 12 in the seller's 16 lots, that were manufactured by Ford® Motor Corporation, manufactured between 1995 and 2000, with a maximum odometer reading of 90000 km, among other stipulations. The results of the search are shown in FIG. 23, showing all vehicles 12 matching the search criteria for that particular segment even if the vehicles may be in multiple geographic locations.

The “My Sales” section 200, contains a row for each vehicle 12 that the seller 16 has submitted to the current auction, although this list may be filtered, as described below. The height of the window changes automatically, so that the entire list is visible. Vehicles 12 in future segments have their details greyed out and vehicles 12 for which the high bid meets the reserve are highlighted, by changing the colour of the text. If the user clicks anywhere on a row, the row is highlighted by changing the colour of the background. The data 65 is sorted in the same way as the “My Bids” section 202, except that the bid type is not available. Optionally, the detail button can be actuated to reveal a more comprehensive report of the specific vehicle 12.

The “My Sales” section 200 includes the following fields: Sold, which shows the total amount of all the seller's 16 sales so far in the current auction. As described above, a Segment Filter shows which vehicles 12 are listed from the current auction, and includes values such as “All segments” showing each vehicle that the seller 16 is selling in the entire auction, and “Active segments” showing each vehicle that seller 16 is selling, for which bidding is open or negotiation is in progress. Also, there is a “Sold” field showing vehicles 12 that the seller 16 has sold.

Another field is “Status” where any of the following rules is applied in the order that they are listed, until one of the rules is successful. If there are offers, this shows the number of hours, minutes and seconds before the first offer expires. If the auction is suspended, and the auction has started, and the bidding for the vehicle is in progress or has not started, this shows “Suspended”. If vehicle 12 has not been assigned to segments, this is blank. If the segment has not started, this shows the segment start time. E.g. 3:45 pm. If the segment is in progress, this shows the number of minutes and seconds before bidding closes. If negotiation is in progress, this shows “Neg”. If a buyer bought the vehicle, this shows “Sold”. If bidding and negotiation are finished, and it is on the cyberlot this shows “Offers”. If bidding and negotiation are finished, and it did not sell, this shows “NoSale”.

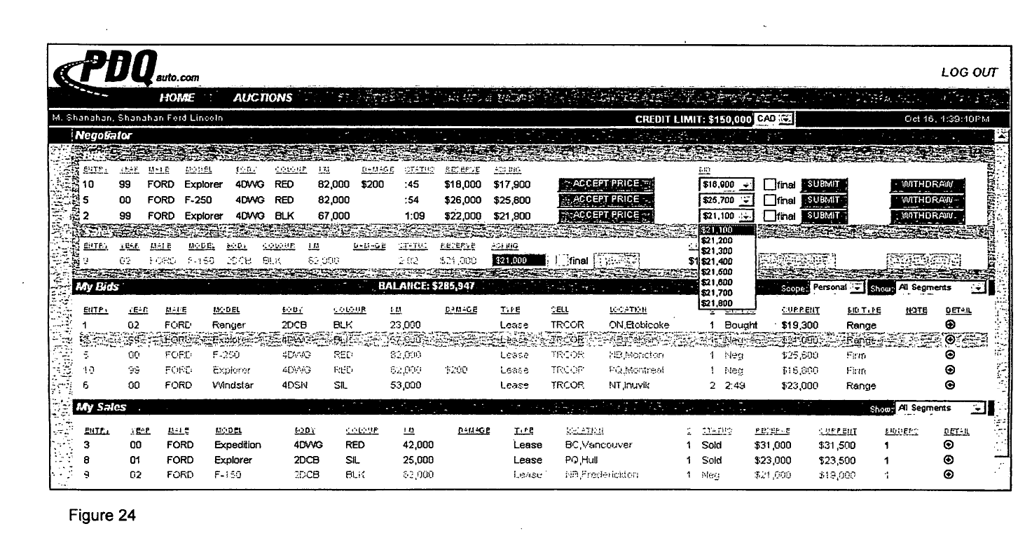

Also, looking at FIG. 24, the “My bids” section 202 shows a plurality of vehicles a buyer 14 is interested in purchasing. The buyer 14 can also instruct the auction server 26 to search specific auctions and notify the buyer 14 periodically with the search results, via an “available vehicle notification preferences” page 32. Also, the buyer 14 can query the auction server 26 during the auction, for vehicles 12 that are being auctioned that meet the search criteria, or a list is automatically generated and updated on the page 32, in accordance with the “available vehicle notification preferences.

The “My bids” section 202 includes a plurality of fields such as, a balance field, which shows how much money the buyer 14 can spend, and this value is calculated as the lesser of the buyer's 14 credit balance and the buyer's 14 credit balance.

Another field is a buyer filter which allows the buyer 14 to choose a set of vehicles 12 by selected by the Segment Filter parameter. This field includes a drop-down menu for the buyer 14 to choose between Dealer and Personal. By selecting the Dealer value, all of the vehicles 12 that buyer 14 is bidding on are listed in the MYBIDS text area, while selecting Personal, only the vehicles 12 that the buyer 14 is bidding on are listed. However, the Personal is only selectable where this only the buyer 14 has more than one registered buyer 14.

Another field, a Segment Filter shows which vehicles 12 are listed from the current auction. This field also has selectable values via a drop-down menu such as “All segments” which shows each vehicle that the buyer 14 is bidding on for the entire auction, “Active segments” which shows each vehicle that the buyer 14 is bidding on, for which bidding is open or there is negotiation in progress. Yet another field is “Group bids” which shows all the vehicles 12 in the auction that are in the buyer's 14 bidding groups. This option is only available if the buyer 14 has defined bidding groups ie. sets of individual group together.

Also included is a “Status” field where any one of the following rules is applied:
If the buyer 14 has an active offer, this shows the number of hours, minutes and seconds before the offer expires.
If the auction is suspended, and the auction has started, and the bidding for the vehicle is in progress or has not started, this shows “Suspended”.
If vehicles 12 have not been assigned to segments, this is blank.

If the segment has not started, this shows the segment start time. E.g. 3:45 pm.
If the segment is in progress, this shows the number of minutes and seconds before bidding closes. This automatically counts down until it reaches 0:00.
If negotiation is in progress, this shows “Neg”.
   If the buyer 14 bought the vehicle, this shows “Bought”.

FIG. 24 also shows an amount of the Current Bid and a Bid Type that the buyer 14 last submitted for the vehicle. The Bid Type may be range bid, a firm bid or an offer. There is also provided a “Note” field where a buyer 14 may set a personal reminder, such as a maximum amount that the buyer 14 is prepared to bid. Also, there is provided a link to a “Vehicle Detail” page 32. If the vehicle details were changed during a predetermined time prior to the auction, there is provided an indicator, typically an asterisk appears on that row.

Another field is “Current Bid” which shows any active offers, and shows the amount of the first offer. If the auction has not started, this shows the number of offers that have been forwarded to the seller 16. A “Detail” field allows submission of vehicle details via a “Submit Vehicle Details” page 32. Other fields include Auction Number, Year, Make, Model Body Colour, Mileage, Damage, Type, Location and Segment which are similar to those that appear in the “My Bids” window 202.

The “Auction Monitor” section 204, allows a buyer 14 to monitor bids within a specific auction. The home page 32 includes a plurality of fields or criteria, arranged as columns, related to vehicles 12 in the auction, such as Auction number, Year, Make, Model, Body Colour, Mileage Type, Segment, Status, Current bid, and Bid type. These criteria represent a primary sort key, the buyer 14 can change the sort sequence by clicking on the header of one of the columns or primary sort key. This section 204 excludes vehicles 12 that the buyer 14 is selling, and vehicle 12 for which the buyer 14 has placed a bid. In other words, it excludes vehicle 12 that can appear in “My Bids” window 202 or “My Sales” window 200. However, if the buyer 14 has stopped bidding on a vehicle, he can move it from “My Bids” window 202 into “Auction Monitor” window 204. The window 204 also excludes vehicles 12 that have been withdrawn by the seller 16, and vehicles 12 that are restricted and are unavailable to the buyer 14.

With the population of this “Auction Monitor” window 204, as vehicles 12 are added in that segment, the height of the window 204 changes automatically, so that the entire list of vehicles 12 is visible. Using behaviours and events, as described above, vehicles 12 in future segments have their details greyed out, while vehicles 12 for which the buyer 14 holds the high bid or has an active offer are highlighted, by changing the colour of the text. Also, when the buyer 14 clicks anywhere on a row, the row is highlighted by changing the colour of the background of the selected row of text.

The bidder 14 makes bids such as a fixed bid range bids, or group bids i.e. bid of a single fixed value, via the bid section 206. The layout of the bid bar 206 is dynamic, as shown in FIG. 20. However, the selected vehicles 12 details appears in the bid bar 206 if the buyer 14 does not have a bid for the vehicle awaiting processing, or the bid bar 206 remains empty until the bid is processed if the buyer has a bid for the vehicle that is awaiting processing.

Once the auction starts, the current bids and the number of bidders 16 are indicated, FIG. 24.

A range bid consists of an initial bid (i.e. the first amount that the buyer 14 wants to bid for the vehicle 12) and an upper bid (i.e. the maximum amount that buyer 14 wants the bid to be raised to). The bid can be entered in either the auction currency or the buyer's 14 preferred currency, but it is converted to the auction currency and rounded down to a multiple of the bidding increment.

The initial bid defaults to (upper bid×initial bid percentage), however, the buyer 14 can override this default. The ratio of the initial bid to the upper bid is less than the “initial bid percentage” parameter. The difference between the upper bid and the initial bid is chosen not to exceed the “range bid maximum spread” parameter. This prevents a situation where a range bid competing with a firm bidder requires a lot of manual bids to establish the winning bid. A buyer 14 cannot submit more than one range bid or group bid on the same vehicle 12. A buyer 14 cannot modify a range bid or group bid that was submitted by a different buyer 14 from the same dealership. When submitting a range bid, the buyer 14 can also select the shipper who will deliver the vehicle 12 if his bid is successful.

A range bid is not processed until the vehicle's 12 auction segment is started. At any time before the starting bid is submitted for a vehicle 12, the buyer 14 can change his initial bid and upper bid. During the auction segment, the buyer 14 can change the upper bid, if the upper bid is increased, then the new amount must be greater than the high bid. However, the upper bid can only be reduced if it is greater than the high bid or if no other bid has been accepted for the vehicle 12. If he tries to change it to an amount that is less than the high bid, it is changed to the high bid instead. If the resultant upper bid is less than the initial bid, the initial bid is set to the upper bid.

A buyer 14 can submit a firm bid for a vehicle 12 for which bidding is open. If a high bid has not been established for the vehicle 12 (i.e. no bids have been accepted), the buyer 14 can submit a starting bid. If the bid is in a different currency from the auction's currency, it is converted to the auction currency and rounded down so that it is a multiple of the bidding increment. Generally, the starting bid amount is a multiple of the bidding increment. If a buyer 14 submits an incorrect bid, he is prompted to enter the correct amount. In order to reduce the likelihood that the buyer 14 will enter an incorrect starting bid, the buyer 14 is prompted for confirmation of the amount before it is accepted. If the amount is more than 110% of the reserve, the buyer 14 is prompted again for confirmation. If a high bid has been established for the vehicle 12, the buyer 14 can submit one of 5 pre-defined incremental bids. These are calculated as follows: for example if the high bid >=$8950, (i.e. 1 bidding increment less than the amount where the bidding increment increases) increase the high bid by $100, $200, $300, $400, $500. Otherwise, if the high bid <$8950, increase the high bid by $50, $100, $200, $300, $400. If the bid causes the buyer 14 to exceed his self-imposed auction limits for the number of vehicles 12 or amount to spend, the buyer 14 is asked to confirm the bid.

A buyer 14 can also make a list of similar vehicles 12 in a single auction that the buyer 14 wants to purchase, along with limits on how many he will purchase. This list is called a bidding group, which can be built and modified any time before the end of the final segment in the auction. By building bidding groups, the buyer's 14 range bids for multiple vehicles 12 are used more effectively, and it increases the likelihood that he will purchase the number of vehicles 12 that he wants. Thus, the buyer 14 can query the auction database 24 for vehicles 12 matching a predetermined criteria in order to form a bidding group. For each vehicle 12 in the group, a range bid is provided. For each group, the buyer 14 can specify the maximum number of vehicles 12 that will be purchased and/or the maximum amount of money that he will spend. The auction server 26 ensures that these limits are not exceeded. As an example, a buyer 14 may build a bidding group made up of 20 Ford Tauruses, but stipulate that he only wants to buy 5 of them and he doesn't want to spend more than $48,000. The auction holder 22 will then monitor the number and amount of successful bids and once one of the limits is reached will inhibit further bids. If, for example, 4 cars have been purchased for $40,000.00, the bid on the fifth car will be prevented if it exceeds $8,000.00. In that case, the buyer will drop out and bid on the next one of the cars to become available, up to a maximum of $8,000.00.

For each vehicle 12 in the auction segment that has recently finished, bidding terminates after no bids have been accepted for the vehicle 12 for a 30 second period. This prevents a buyer 14 from outbidding other buyers 14 by submitting a bid right at the segment deadline; a competing buyer 14 always has sufficient time to respond to a bid that has replaced his high bid. If no bids have been received for a vehicle 12 during the final 30 seconds of the auction segment, bidding terminates at the end of the segment. Invalid bids do not extend the close of bidding, since this could be open to abuse as a dealer could keep submitting invalid bids and cause bidding to remain open for a long time.

For each vehicle 12, the following actions can be taken: a “cancel bid” process to close all range bids, which ensures such bid will not be used again if the vehicle 12 is re-listed. If the vehicle 12 has been withdrawn by the auction holder 22, it is not sold. If the high bid meets the reserve, the high bid becomes the selling price, and the vehicle 12 will be sold to the high bidder. Subsequently, the high bidder is informed that his bid was successful. Other bidders 14 with lower bids are also informed that their bids were unsuccessful.

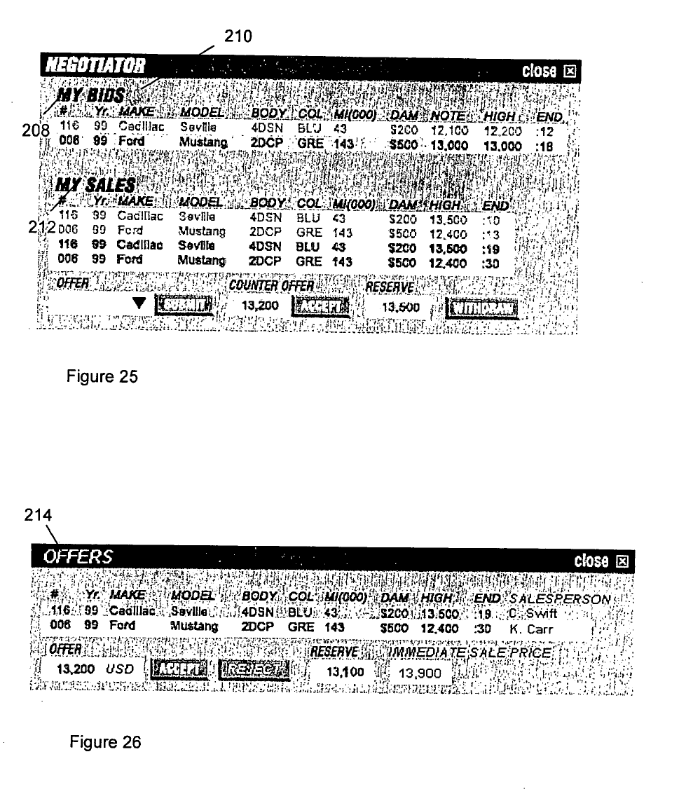

If the high bid does not meet the reserve, the high bidder 14 may have an option to negotiate the sale of the vehicle 12 via a negotiation module or negotiator, as shown in FIG. 25. The bidder 14 and the seller 16 go through a sequence of offers and counter offers until a mutually acceptable price is met, and the vehicle 12 is sold.

Typically, the process of negotiating is initiated if the seller 16 chooses to negotiate, and the process can go through multiple cycles. The buyer 14 is shown the reserve price and the seller's 16 offer price. Each time a new offer is received from the salesperson, the buyer 14 has the options of accepting the seller's 16 offer price, withdrawing from the negotiations, or submitting a counter offer to the seller 16. This consists of a proposed selling price that is greater than his previous high bid or counter offer. If the offer amount causes him to exceed his self-imposed auction limits for the amount to spend, he is asked to confirm his offer. If the seller 16 accepts the offer or submits a counter offer, then the buyer's 14 credit balance is reduced by the difference between the offer and the high bid. If this is unsuccessful, the offer is rejected. The vehicle's 12 high bid is replaced by the offer amount. If the buyer 14 accepts the offer, the sale will be completed.

The negotiator window 208 includes a “My Bids” section 210 which contains a list of vehicles 12 for which the current user has the high bid, and the high bid is lower than the reserve, and the salesperson has submitted an offer. This window pops up automatically for the buyer 14 if the salesperson submits an initial offer on such a vehicle 12, as shown in FIG. 26. When the window pops up, or a new vehicle 12 is added to the window, a sound plays, to alert the user if he is not currently watching the monitor. Another section within the negotiator window is a “My Sales” section 212, which contains a list of vehicles 12 for which the current user is the seller 16, and bidding has closed, and the high bid is lower than the reserve. This window pops up automatically for the seller 16 whenever such a vehicle 12 reaches the negotiation stage. The window is automatically refreshed every 5 seconds by the live update sub-system 46. The automatic refreshing stops when negotiation has ended. The vehicles 12 are sorted by the end time and the auction number, in ascending order.

The “My Bids” section 210 and the “My Sales” section 212 include the following fields: Auction number, Year, Make, Model, Body, Colour, Mileage, Damage, Status, Note, Asking, Reserve, and Bid. The status field includes a countdown timer that shows the remaining time before the user may initiate or respond to the offer. Generally, the timer starts at 3 minutes, and whenever a bid or asking price is submitted, this is reset to 3 minutes. The Bid/Asking field shows an amount that the buyer 14 or seller 16 offers as a sale price for the vehicle 12. This is pre-populated as a set of up to 10 amounts, for a seller 16 this field's label is labelled “Asking”, else it is labelled as “Bid” for the buyer 14

If the two participants 14, 16 have not agreed on a sale price before the countdown timer reaches zero, the vehicle 12 remains unsold. Using events as described above, if it is one of the dealer's turn 14 or 16 turn to make an offer on a vehicle 12, the text is black, and if it is the other dealer's 14 or 16 turn to make an offer, the text is grey. When the dealer 14, 16 clicks on a row and it is his turn to make an offer, then that selected row is highlighted and any highlighting previously present on any other rows is removed and the counter offer by the other dealer 14 or 16 and reserve fields are populated.

The seller 16 can review the offers that are awaiting his decision in an “Offers” window 214. This window 214 contains a list of the seller's 16 vehicles 12 in the current auction for which a buyer 14 has submitted an offer that is awaiting a decision, as shown in FIG. 26. This pops up automatically for the seller 16, if there are offers that require his approval. The seller 16 can configure the properties of the “Offer” window 214 to show offers for all of the seller's 16 vehicles 12 or just those that he listed. Generally, the vehicles 12 are sorted by the expiry time and the entry number.

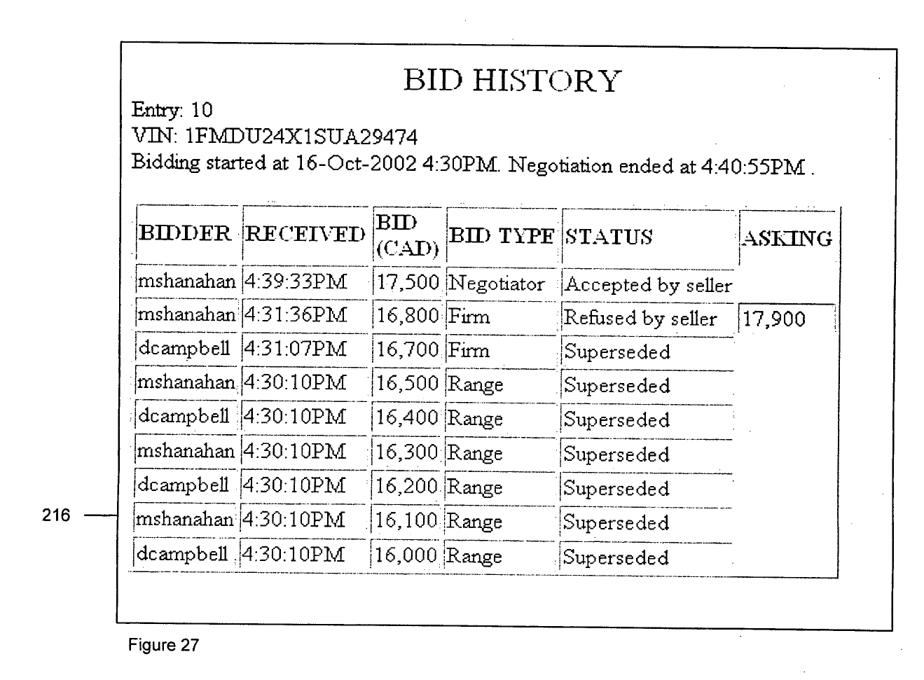

At the conclusion of the auction, a bid history 216 is assembled and presented on a webpage 23 when the buyer 14 has submitted a valid firm bid, or the buyer 14 has submitted a range or group bid, and this has generated a bid, as shown in FIG. 27. The bid history shows the chronology of the bidding for a particular vehicle 12, and includes the bid types, asking price, bidding currency and status and time of offers and counter-offers, and so forth. It will be seen therefore that the system 10 simulates and “line” auction and facilitates control and monitoring of the auction process.

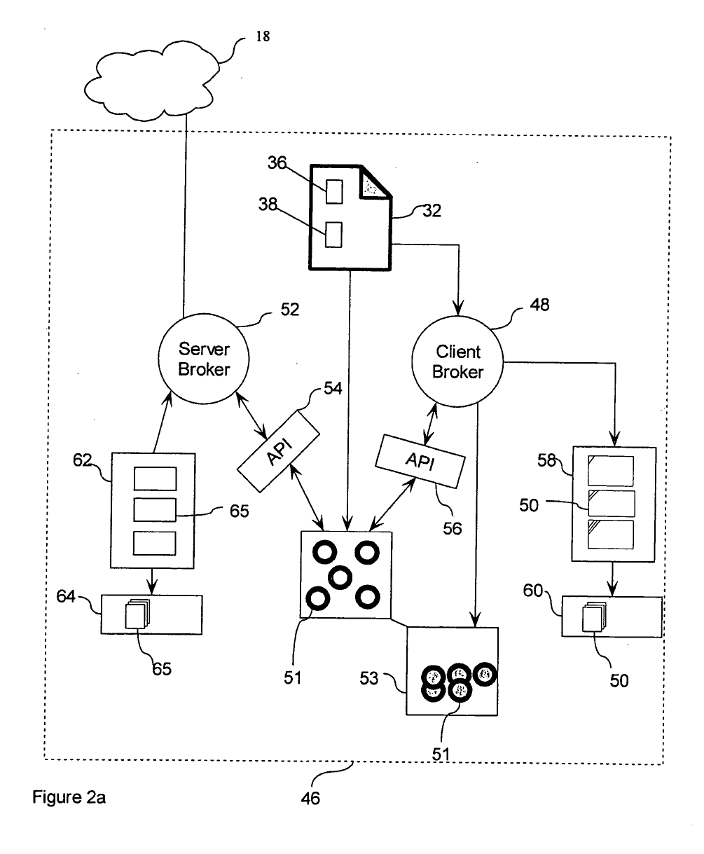

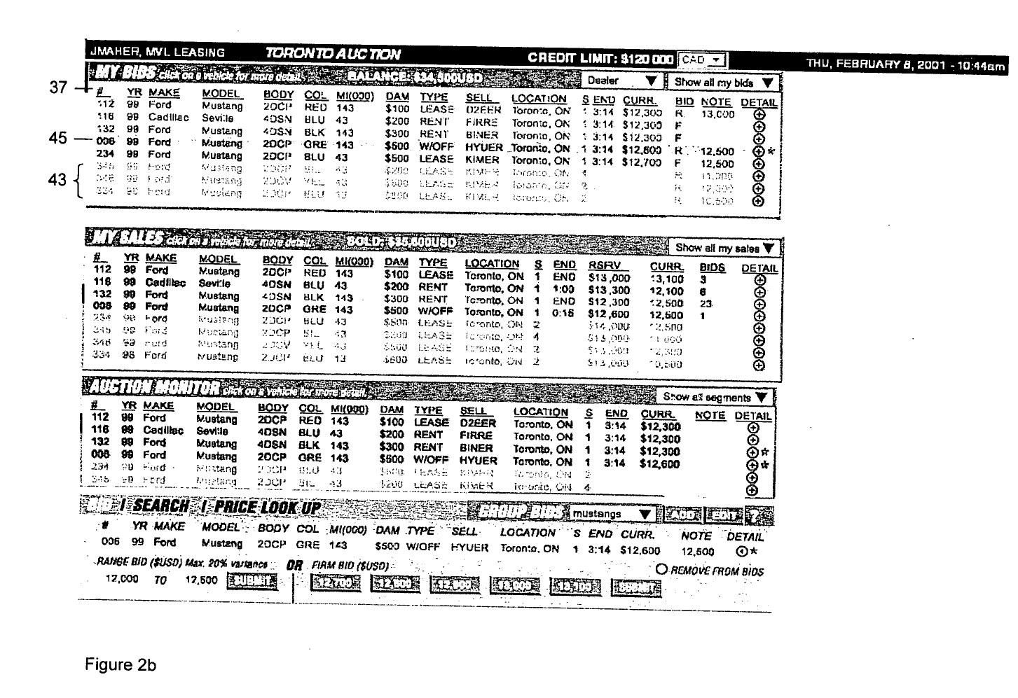

However, in order to maintain the currency of the bid information it is necessary to ensure that the data is updated in real time, i.e. without significant delay. The web page 32 pin which the information is presented includes a combination of authoring languages, such as Hyper Text Markup Language (HTML), Extensible Markup Language (XML) and Javascript®. The structure and layout of the XML/HTML document 32 is defined by a plurality of building blocks such as Elements, Tags, Attributes, Entities, PCDATA and CDATA. Elements 36, 38 are the main building blocks of both XML and HTML documents 32, and may contain text, other elements 36, 38, or be empty. Tags are used to markup elements 36, 38, for example a starting tag like <element_name> marks up the beginning of an element 36, 38, and an ending tag like </element_name> marks up the end of an element 36, 38. Tags are commands within the document 32 that specifies how that document 32, or a portion of the document 32, should be formatted. Attributes provide extra information about elements 36, 38 and are generally placed inside the starting tag of an element 36, 38. Typically, attributes come in name/value pairs. Entities are variables used to define common text and are expanded when the document 32 is parsed by an XML parser. PCDATA is parsed character data, which is text found between the start tag and the end tag of an XML element 36, 38. Meanwhile, CDATA is character data which is not parsed by a parser, such that tags inside the text will not be treated as markup and entities will not be expanded. For example, FIG. 2b shows an example of an auction page 32 with a plurality of vehicles 12 presented in a row by row format. Therefore, the auction page 32 includes static elements 36 such as row header 37 including details of the vehicle such as year of assembly, model type, price and so forth. Also included in the auction page 32 are dynamic elements 38, which include auction countdown timer 39 or current bid value 41. Using behaviours associated with rows and actions by the dealer 14 or 16, vehicles 12 in future auction segments have their details greyed out, as indicated at 43, while vehicles 12 for which the buyer 14 holds the high bid or has an active offer may be highlighted, by changing the colour of the text. Through events such as mouserover or onclick, when the buyer 14 clicks anywhere on a row, the row is highlighted, as indicated at 45, by changing the colour of the background of the selected row of text.

Due to the inherent fast-paced nature of an auction, the web page 32 requires constant updating to reflect the status of the auction in real-time. However, instead of performing a “hard refresh” in which the whole web page 32 is rendered, only the dynamic elements 38 of the web page 32 that have changed are requested from the server 26 via the web server 30. As mentioned above, the page 32 includes a number of dynamic fields or dynamic page elements 38 such as number of vehicles 12 being auctioned, number of bidders 16, auction system time, auction countdown time and value of current bids. During the auction, any dynamic page elements 38 are automatically updated and thus the webpage 32 is automatically refreshed via the live-update subsystem 46, without a hard refresh. As an example, the dealer 14, 16 queries the auction database 28 via the web page 32, and the web page 32 is updated without performing a hard refresh. Both request and response include an XML string, such that the request from the dealer computer 34's web browser to the web server 30 is via an XML/HTTP protocol. This protocol is implemented in XML, and uses http as its transport mechanism.

To permit the refresh of the dynamic elements 38, the dynamic elements 38 are registered with a component registry within the web client or browser at the dealer computer 34. Typically, the webpage 32 contains the initial display state of the user interface, as well as custom tag attributes that are associated with a particular class. The system 10 includes an update sub-system 46 between client and server that allows the display of live data and supports object interaction. As shown in FIG. 2, the update sub-system 46 includes a client broker 48 that manages classes and object instances therein. The client broker 48 scans the loaded webpage 32 and associates tags with classes 50 to be instantiated. When a tag is recognized, the corresponding class 50 is retrieved via a server broker 52. Generally when a class object 50 is called, a new class instance 51 is created and returned. Class instances 51 are the instantiated classes 50 that are attached to page elements 36, 38 in the webpage 32. The class instances 51 perform the dynamic function of data retrieval and manipulation for the live data display, and are collected by a class instance collector 53. Data is requested and retrieved through the server broker's API Interface 54 via the XML/HTTP protocol, such as a transvortex protocol.

The transvortex carries three core types of information, encoded classes 50 called hydrapods 51; data called datapods; and session data called session. Each of these components can contain their own Document Type Definitions (DTD) specific to each implementation. A DTD defines the legitimate building blocks of an XML document. It defines the document 32 structure with a list of legitimate elements.

For example, a Transvortex DTD is represented as:

Transvortex DTD
<!DOCTYPE transvortex [

< ! ELEMENT session ( #PCDATA) >
< !ELEMENT datapod ( #PCDATA) >
< !ELEMENT hydrapod ( #PCDATA) >

] >

Hydrapods 51, are classes 50 that can be instantiated on the client side or at the dealer computers 34, but whose details originate from a remote location, such as a server 30. The following DTD is the standard style of definition for a scripting language. The DTD would change if used to define a bytecode language, or some other form of class serialization.

< ! DOCTYPE hydrapod [

<! ELEMENT behavior (class+) >
< ! ELEMENT language (#PCDATA) >
< ! ELEMENT class (documentation?, method+) >
< ! ELEMENT method (#PCDATA) >
< ! ELEMENT documentation (#PCDATA) >
< ! ATTLIST class name CDATA #REQUIRED>
< ! ATTLIST class args CDATA #IMPLIED>
< ! ATTLIST method name CDATA #IMPLIED>
< ! ATTLLST method type CDATA #REQUIRED>
< ! ATTLIST method args CDATA #IMPLIED>
< ! ATTLIST method event CDATA #IMPLIED>

] >

A hydrapod 51 typically includes three types of methods to define these objects, Instantiator, Member and Event. An instantiator method executes the code within the instantiator tag when this class is instantiated into an object, and multiple instantiator tags are specified within one class, they will be concatenated in order of appearance. A member method is a simple class method and includes a name attribute specifying the name of the method, and the args attribute specifies a comma-delimitated list of arguments that the method. An event method includes onclick events and onmouseover events and includes corresponding callback names. Such events also have an event attribute which specifies the event channel this method should listen on onclick, onmouseover and so forth.

Generally, event methods pass an event object as the first argument and hydrapods 51 can use these event objects to pass arguments. The client broker 48 includes an API Interface 56 through which instantiated hydrapods 51 communicate with one another, and create new hyrdrapod instances 51. For example, the client broker 48 interface includes functions to broadcast an event to all hydrapods 51 that are listening or limit the scope of the broadcast to a specific element or window, or broadcast to the first parent of that element that is listening for that particular event. The client broker 48 is coupled to a hyrdrapod class collector 58 and a hyrdrapod store 60. The hyrdrapod class collector 58 is a reference counter for the hyrdrapod store 60, such that the hyrdrapod class collector 58 and hyrdrapod store retrieve and maintain requested classes 50 for the client broker 48, such that the client broker 48 can instantiate previously requested classes 50 without having to request them from the web server 30.

A server broker 52 manages the request and retrieval of data from the web server 30 on behalf of the class instances 51 or the client broker 48. The server broker 52 receives requests through its API interface 54, and references a datapod collector 62 for copies of the requested data 65. The server broker API 54 includes the functions of registering any class 50 that downloads XML for an element upon instantiation, removes classes 50 from the XML download registry, searches through registered XML classes 50 whose state has been set init, and loads their XML. The datapod collector 62 is a reference counter for a datapod store 64. The datapod collector 62 and the datapod store 64 retrieve requested data 65 for the server broker 52. The datapod collector 62 and the datapod store 64 allow the server broker 52 to return previously requested data 65 without having to request it again from the web server 30. If the requested data 65 does not exist, or is out of date, the server broker 52 retrieves the data 65 from the server via a logical connection between the live update sub-system 46 and the web server. Generally, communication between the live update sub-system 46 and the web server occurs via the HTTP/XML protocol and XML data 65 travels from the server at the request of the server broker 52.

Dynamic access and update of the content, structure and style of the XML/HTTP documents 32 is achieved in conjunction with Document Object Model (DOM), a platform- and language-neutral interface that allows programs and scripts to perform such functions. Thus the Document Object Model provides a standard set of objects for representing HTML and XML documents 32. For example, given a DOM object the client broker API 56 includes functions to instantiate hydrapods 51 for elements that are descendants of rootElement, including rootElement itself, removing a hydrapod 51 from the client broker 48, removing hydrapods 51 from an element, adding basic validation rules (bvr) to an element by attaching a class bvr to the element, including setting up events. Each class 50 has member variables “element” and “REGISTRY” which point to the element that class 50 is associated with, and the global REGISTRY object, and returning an array of all behavior instances of class bvrName.

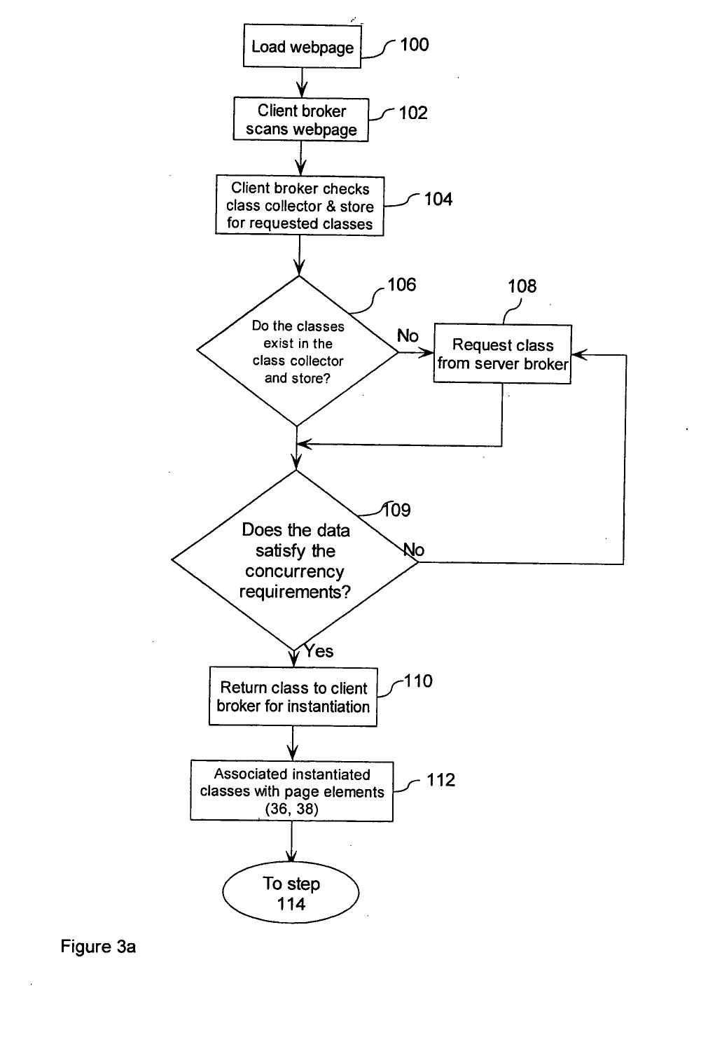

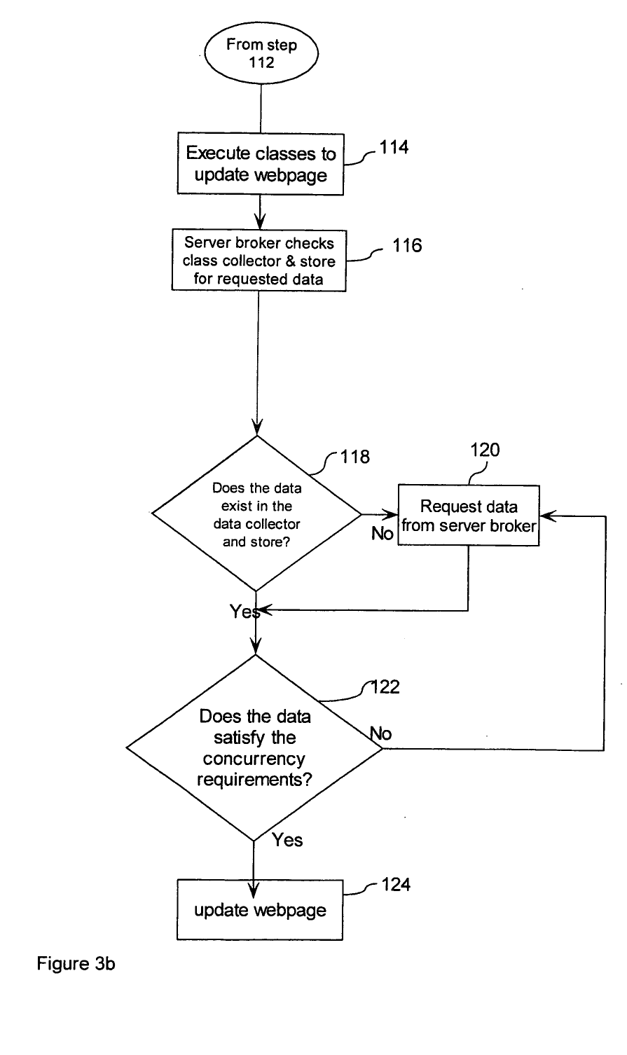

Generally, an HTML document 32 is updated dynamically and in real time by the live update system 46 via a number of steps outlined below and shown in FIG. 3. Initially at step 100, the HTML Document 32 is loaded into the web browser, and, in the next step 102 the HTML document 32 is scanned by the client broker 48 in order to recognize tag attributes of elements 36, 38 that are to be associated with hydrapod class instances 51. In step 104, client broker 48 references the class collector 58 and class store 60 for the associated hyrapod classes 50. A determination is made in step 106 whether the hyrapod classes 50 already exist. If it is determined that the hyrapod classes 50 do not exist in the class store 60, the client broker 48 requests at step 108 the hyrapod classes 50 from the server broker 52 via the server broker API interface 54. Otherwise the hyrapod classes 50 are returned to the client broker 48 for instantiation, step 110. Also, determination is made in step 109 whether the hydrapod classes 50 in the class store 60 satisfy the concurrency requirements or are out of date. If the concurrency requirements are not met then client broker 48 requests the hyrapod classes 50 from the server broker 52 via the server broker API interface 54.

In step 112, once the hyrapod classes 50 are instantiated and associated with respective page elements 36, 38, the custom functionality built into the hyrapod classes 50 are executed to update the web page 32, step 114. In the next step 116, the server broker 52 receives data 65 requests from the hyrapod classes 50 or the client broker 48. In step 118, a determination is made by the server broker 52 whether the request has already been made by referencing the datapod collector 62 and store. If the datapod store 64 cannot satisfy the request, the server broker 52 initiates a data 65 request from the server via the XML/HTTP protocol, in step 120, otherwise in the case of a class request, a determination is made whether or not the existing data 65 in the data store 64 satisfies the concurrency requirements of the requesting object, step 122. If the concurrency requirements are not met, the server broker 52 initiates a data 65 request from the auction server 26 via the web server 30 in step 120. The document 32 is updated in step 124.

As an example, suppose a vehicle 12 has a current bid price of $12, 300, this value is presented on the web page as a “Current Bid” element, which is a dynamic element, and the tag attributes include the “$” symbol and the figure “12,300”. If another bidder 14 puts in a new bid, this new bid is detected by the client broker 48 and broadcast to all hydrapods 51 that are listening. The dynamic element “12, 300” is defined by a class object 50, and when the class object 50 is called in order to check any changes in the bid value, a related class instance 51 is created. This class instance 51 checks the class collector 58 and class store 60 to determine whether a class instance 51 pertaining to the change in the “Current Bid” value is present therein. If this new bid value of $13,000 is not present, the bid broker 48 initiates a request from the server broker 52, and the a new class instance 51 is retrieved from the auction server 26, and the “Current Bid Value” is updated on the web page 32 by the web server 30, and server to the dealer computers 34. This new bid value is then stored in the class store 60 for future reference.

Accordingly, it can be seen that the information is updated dynamically without significant delay and without loss of informational content or organisation.

1. An auction system for conducting an online auction of merchandise in a plurality of lots presented on a webpage between a bidder and a seller in a communication network, said system having:
a host computer associated with an auction host;
a bidder computer and a seller computer coupled to said host computer;
said computers having a computer usable medium having a plurality of program codes for executing instructions pertaining to said auction; said plurality of program codes including:
a first computer readable program code for administering and managing said auction by defining characteristics and parameters of said auction as dictated by said auction host;
a second computer readable program code for defining said webpage interface presented on said bidder computer and said seller computer;
a third computer readable program code for defining real-time updating of dynamic elements within said webpage associated with a status of sale of said merchandise;
a fourth computer readable program code for defining a method for recording actions of said bidder and said seller to the host computer in real-time and presenting said actions on said webpage in real-time;
a fifth computer readable program code for enabling negotiation of a sale of said merchandise between said bidder and said seller after a predetermined time as specified is said parameters;
wherein said auction is conducted in real-time between said bidder and said seller within said network.

2. The system of claim 1 wherein said bidder specifies bids for merchandise via a sequence of forms on said webpage to hand off bid information to an auction server, said auction server executing said auction programs to implement said auction in accordance with said parameters, and said bid information being stored in an auction database.

3. The system of claim 1 wherein said auction database includes a daemon process for monitoring the auction database for events to process or bids to verify, each auction program can be implemented in multiple concurrent processes, each one managing a different auction.

4. The system of claim 1 wherein said auction parameters may be changed when said auction is in progress.

5. The system of claim 1 wherein said webpage interface includes a section for said seller to monitor said seller's merchandise in said auction, a section for said bidder to monitor to merchandise said bidder is bidding on, a section to monitor bids on said merchandise and a section to enter bids.

6. The system of claim 1 wherein said webpage interface includes a section for negotiating said sale of merchandise between said bidder and said seller, and a section for making offers and counter-offers.

7. The system of claim 1 wherein said fifth computer readable program code include an offer program code for processing offers and counter-offers during said negotiating, and said offer program code allowing accepting and withdrawing of said offers and counter-offers.

8. The system of claim 1 wherein said merchandise is presented on said webpage in a row by row format, each row having a plurality of descriptor fields associated with each of said merchandise.

9. The system of claim 8 wherein said merchandise are vehicles, and said descriptor fields including a vehicle unique identifier, year of assembly, make, model, body colour, mileage, type, auction segment, status of sale, current bid, and bid type.

10. The system of claim 9 wherein said bid type includes a range bid, a firm bid or an offer, said range bid and said firm bid being incremented automatically by a predetermined amount as dictated by said bidder.

11. The system of claim 10 wherein a particular group of vehicles having predetermined characteristics are grouped together to form a group bid, each of said vehicles in said group having range bid.

12. The system of claim 2 wherein said bid information is presented to said bidder and said seller in chronological order at the termination of said auction of said merchandise.

13. The system of claim 8 wherein said bidder and seller make a selection of said merchandise to sell, to buy or to monitor, said selection being associated with a unique indicia.

14. The system of claim 1, wherein parameters include a unique identifier for said auction, a schedule time for conducting said auction, said lots of merchandise, pricing, bidding rules, negotiation rules, auction duration time, bidding countdown period, and so forth.

15. The system of claim 1, wherein said real-time updating of dynamic elements within said webpage includes a live-update sub-system for managing and storing said components at said bidder computer and said seller computer, and requesting corresponding up-to-date components from said host computer in order to reflect said real-time actions of said bidder and said seller.

16. The system of claim 16 wherein said live update sub-system includes a client broker at said bidder computer and at seller computer to scan said webpage and associate tags with classes to be instantiated, said client broker to retrieve said classes via a server broker coupled to said host computer, said instantiated classes being attached to said dynamic components.

17. The system of claim 4 wherein said instantiated classes perform the dynamic function of element retrieval and presentation of said elements on said webpage, said elements being requested and retrieved via said server broker using an XML/HTTP protocol.

18. The system of claim 1, wherein said status of sale includes indicia to prompt action by said bidder and said seller.

19. The system of claim 1, wherein said parameters include an overtime extension parameter associated with said one of said plurality of lots.

20. A method of dynamically updating elements included in a document at a client computer in real time from a host computer, said elements having class components and data components and document associated with an online auction, the method having the steps of:
loading said document in said client computer;
scanning said document to recognize said class components and said data components;
collecting and storing said class components at said client computer;
said client computer requesting an update of said class components from said host computer;
determining whether said class components already exist at said client computer;
requesting said class components from said host computer if the class components do not exist at said client computer, otherwise instantiating said class components to yield class instances; executing said class instances;
said client broker requesting an update of said data components from said host computer via said server broker;
said server broker determining whether said request for update of said data components has already be made by referencing a data collector and store;
said server broker initiating a data request from said server if said data collector and store do not have said update of said data; else a determination is made whether existing data components in said data collector and store is current, said server broker initiating a data request from said host computer; and
updating said data components and class components on said webpage.

21. A method of conducting an online auction between participants in a communication network, said method having the steps of:
presenting a plurality of merchandise on a webpage;
associating said merchandise with a status of sale,
said webpage having dynamic elements pertaining to said status of sale;
changing said status of sale dynamically and in real time in response to actions by said participants.
